(19) United States
(12) Patent Application Publication
(10) Pub. No.: US 2025/0068906 A1
(43) Pub. Date: Feb. 27, 2025

(54) CALCULATION DEVICE, LEARNING DEVICE, AND CALCULATION METHOD

(71) Applicant: NEC Corporation, Tokyo (JP)

(72) Inventor: Yusuke SAKEMI, Narashino-shi (JP)

(73) Assignee: NEC Corporation, Tokyo (JP)

(21) Appl. No.: 18/810,953

(22) Filed: Aug. 21, 2024

(30) Foreign Application Priority Data
Aug. 25, 2023 (JP) 2023-136928

(51) Int. Cl. G06N 3/08; G06N 3/049

(52) U.S. Cl. CPC G06N 3/08; G06N 3/049

(57) ABSTRACT

A calculation device converts, for each input signal to a spiking neuron model, the input time of the input signal, into a discrete-time input value, which is a value at a discretized time, calculates the membrane potential of the spiking neuron model at the discretized time, based on the discrete-time input value, and calculates the firing time of the spiking neuron model, based on the calculated membrane potential.

This application is based upon and claims the benefit of priority from Japanese patent application No. 2023-136928, filed on Aug. 25, 2023, the disclosure of which is incorporated herein in its entirety by reference.

### TECHNICAL FIELD

The present disclosure relates to a calculation device, a learning device, and a calculation method.

### BACKGROUND ART

Spiking neural networks may be trained using a spiking neural network that is composed of a mathematical model.

For example, PCT International Publication No. WO2022/249308 (Patent Document 1) describes that after training a spiking neural network using a non-discretized mathematical model, the trained mathematical model is implemented in a circuit model in which the firing time of a spike generator, the weight of a synapse circuit, and the output current value of the synapse circuit are discretized.

In the method described in Patent Document 1, the trained mathematical model that is not discretized is converted into a mathematical model in which the firing time and weight are discretized, and the mathematical model in which the firing time and weight are discretized is implemented in a circuit model in which the firing time and weight are discretized.

In converting from a non-discretized mathematical model to a discretized mathematical model, the firing times and weights are rounded to discrete values.

In addition, in order to improve the accuracy of implementing a discretized mathematical model in a discretized circuit model, at the time of design, at least one of; a firing time increment of a spike generator, the minimum increment of a current value output by a synapse circuit, a firing threshold voltage of the spike generator, the capacitance of a capacitor that simulates a membrane potential, the firing time increment of a mathematical model, and the weighting increment of the mathematical model is determined such that, the product of the firing time increment of the mathematical model and the weighting increment of the mathematical model, is equal to a value obtained by dividing the product of the firing time increment of the spike generator and the minimum increment of the current value output by the synapse circuit, by the product of the firing threshold voltage of the spike generator and the capacitance of the capacitor.

### SUMMARY

In a case where performing calculations using a spiking neural network composed of a mathematical model, such as in a case where learning a spiking neural network composed of a mathematical model, it is preferable that the time required for calculation is short.

One example of the object of the present disclosure is to provide a calculation device, a learning device, a calculation method, a learning method, and a program that can solve the above-mentioned problem.

According to a first example aspect of the present disclosure, a calculation device includes: a discretization means that converts, for each input signal to a spiking neuron model, an input time of the input signal, into a discrete-time input value, which is a value at a discretized time; a membrane potential calculation means that calculates a membrane potential of the spiking neuron model at the discretized time, based on the discrete-time input value; and a firing time calculation means that calculates a firing time of the spiking neuron model, based on the calculated membrane potential.

According to a second example aspect of the present disclosure, a learning device includes: a discretization means that converts, for each input signal to a spiking neuron model, an input time of the input signal, into a discrete-time input value, which is a value at a discretized time; a membrane potential calculation means that calculates a membrane potential of the spiking neuron model at the discretized time, based on the discrete-time input value; a firing time calculation means that calculates a firing time of the spiking neuron model, based on the calculated membrane potential; an output value calculation means that calculates an output value of a spiking neural network using the spiking neuron model, based on the firing time; and a learning means that updates values of learning parameters of the spiking neural network, based on the output value.

According to a third example aspect of the present disclosure, a calculation method includes computer-implemented steps of: converting, for each input signal to a spiking neuron model, an input time of the input signal, into a discrete-time input value, which is a value at a discretized time; calculating a membrane potential of the spiking neuron model at the discretized time, based on the discrete-time input value; and calculating a firing time of the spiking neuron model, based on the calculated membrane potential.

According to a fourth example aspect of the present disclosure, a learning method includes computer-implemented steps of: converting, for each input signal to a spiking neuron model, an input time of the input signal, into a discrete-time input value, which is a value at a discretized time; calculating a membrane potential of the spiking neuron model at the discretized time, based on the discrete-time input value; calculating a firing time of the spiking neuron model, based on the calculated membrane potential; calculating an output value of a spiking neural network using the spiking neuron model, based on the firing time; and updating a value of a learning parameter of the spiking neural network, based on the output value.

According to a fifth example aspect of the present disclosure, a program causes a computer to execute steps of: converting, for each input signal to a spiking neuron model, an input time of the input signal, into a discrete-time input value, which is a value at a discretized time; calculating a membrane potential of the spiking neuron model at the discretized time, based on the discrete-time input value; and calculating a firing time of the spiking neuron model, based on the calculated membrane potential.

According to a sixth example aspect of the present disclosure, a program causes a computer to execute steps of: converting, for each input signal to a spiking neuron model, an input time of the input signal, into a discrete-time input value, which is a value at a discretized time; calculating a membrane potential of the spiking neuron model at the discretized time, based on the discrete-time input value; calculating a firing time of the spiking neuron model, based on the calculated membrane potential; calculating an output value of a spiking neural network using the spiking neuron model, based on the firing time; and updating a value of a learning parameter of the spiking neural network, based on the output value.

### BRIEF DESCRIPTION OF THE DRAWINGS

FIG. 1 is a diagram showing an example of the configuration of a learning device according to at least one example embodiment.

FIG. 2 is a diagram showing an example of the configuration of a spiking neural network that is the learning target of a learning device according to at least one example embodiment.

FIG. 3 is a diagram showing an example of a configuration of a neuron model in a case where configured as hardware according to at least one example embodiment.

FIG. 4 is a diagram showing an example of a change over time in membrane potential of a neuron model according to at least one example embodiment.

FIG. 5 is a diagram showing an example of data input/output in a learning device in a case where calculating the firing time of a neuron model in at least one example embodiment.

FIG. 6 is a diagram showing an example of a process in which a discretization unit according to at least one example embodiment converts an input spike time into a discrete spike sequence.

FIG. 7 is a diagram showing an example of an experimental result of a membrane potential calculated by a learning device, in a case where the number of discrete times for which the membrane potential is calculated is three, in at least one example embodiment.

FIG. 8 is a diagram showing an example of an experimental result of a membrane potential calculated by a learning device, in a case where the number of discrete times for which the membrane potential is calculated is five, in at least one example embodiment.

FIG. 9 is a diagram showing an example of an experimental result of a membrane potential calculated by a learning device, in a case where the number of discrete times for which the membrane potential is calculated is ten, in at least one example embodiment.

FIG. 10 is a diagram showing an example of the results of learning a spiking neural network by a learning device, in at least one example embodiment.

FIG. 11 is a diagram showing an example of a processing procedure by which a learning device according to at least one example embodiment calculates an output value of a spiking neural network.

FIG. 12 is a diagram showing an example of the configuration of a calculation device according to at least one example embodiment.

FIG. 13 is a diagram showing an example of the configuration of a learning device according to at least one example embodiment.

FIG. 14 is a diagram showing an example of the processing procedure in a calculation method according to at least one example embodiment.

FIG. 15 is a diagram showing an example of the processing procedure in a learning method according to at least one example embodiment.

FIG. 16 is a diagram showing an example of the configuration of a computer according to at least one example embodiment.

### EXAMPLE EMBODIMENT

Example embodiments of the present disclosure will be described below, but the following example embodiments do not limit the disclosure according to the claims. Furthermore, not all of the combinations of features described in the example embodiments are necessarily essential to the means of solving the problems of the disclosure.

In the following, a character with a circumflex (\hat{ }) may be written with a superscript circumflex next to the character. For example, t with a circumflex attached is also denoted as t\hat{ }.

### First Example Embodiment

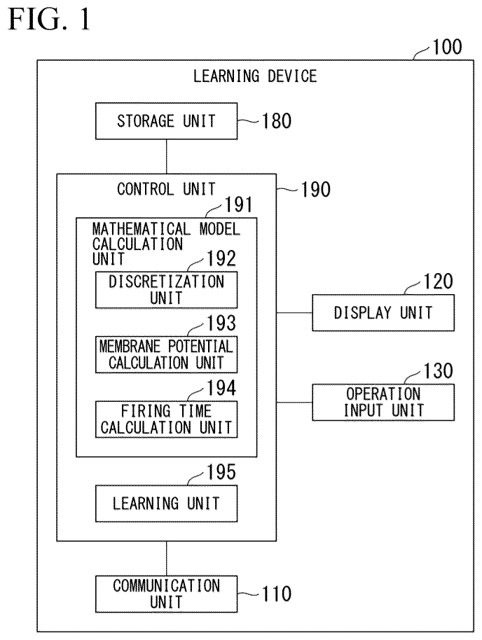

FIG. 1 is a diagram showing an example of the configuration of a learning device according to at least one example embodiment. In the configuration shown in FIG. 1, the learning device 100 includes a communication unit 110, a display unit 120, an operation input unit 130, a storage unit 180, and a control unit 190. The control unit 190 includes a mathematical model calculation unit 191 and a learning unit 195. The mathematical model calculation unit 191 includes a discretization unit 192, a membrane potential calculation unit 193, and a firing time calculation unit 194.

The learning device 100 uses a spiking neural network (SNN) composed of a mathematical model to learn the spiking neural network. The spiking neural network referred to here is a neural network in which a neuron model outputs a signal at a timing based on a state quantity called a membrane potential, which changes over time depending on the input status of a signal to the neuron model itself.

Furthermore, learning a spiking neural network referred to here means acquiring values of learning parameters that improve the accuracy of the processing performed by the spiking neural network.

Learning a spiking neural network by the learning device 100 can also be said to mean that the learning device 100 trains the spiking neural network.

A neuron model of a spiking neural network is also called a spiking neuron model. A signal input and output by a neuron model is also called a spike signal, or simply a spike. A spike input to a neuron model is also called an input spike to that neuron model. An input spike corresponds to an example of an input signal to a spiking neuron model.

The time at which a spike is input to a neuron model is also called the input spike time of that neuron model.

The output of a spike by a neuron model is also called firing. A spike output by a neuron model is also called the output spike of that neuron model.

However, in the spiking neural network that is the learning target of the learning device 100, spikes are not limited to signals of a specific format, and can be various signals that can transmit the firing time.

A spiking neural network composed of a mathematical model is also called a mathematical model of a spiking neural network.

The learning device 100 may be configured using a computer such as a personal computer (PC) or a workstation (WS).

The processing performed by the spiking neural network that is the learning target of the learning device 100 can be various processing that can be executed using a spiking neural network. For example, the spiking neural network that is the learning target of the learning device 100 may perform image recognition, voice recognition, biometric authentication, or numerical prediction, but is not limited to these.

In the following, an example will be described in which the spiking neural network that is the learning target of the learning device 100 is configured as a fully connected feedforward neural network. However, the spiking neural network that is the learning target of the learning device 100 is not limited to a specific network structure.

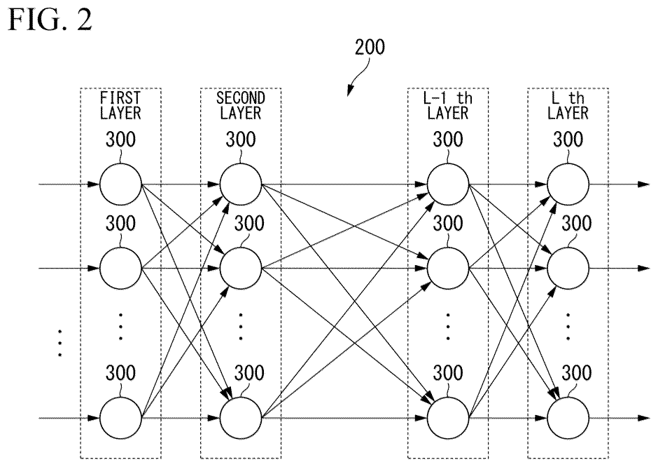

FIG. 2 is a diagram showing an example of the configuration of a spiking neural network that is the learning target of the learning device 100. In the example of FIG. 2, the spiking neural network 200 is configured as a fully connected feedforward neural network with L layers. L is an integer L≥2, which represents the number of layers in the spiking neural network 200.

The spiking neural network 200 uses a temporal method as a method for transmitting information between neuron models, in which information is transmitted at the timing of spike transmission (firing time of the neuron model).

The first layer corresponds to an example of an input layer. The neuron models 300 in the first layer output spikes in response to input signals to the spiking neural network 200.

The second layer to the (L−1)th layer correspond to examples of hidden layers. The neuron models 300 in the l-th layer output spikes in response to spikes from the neuron models 300 in the (l−1)th layer. Here, l is an integer such that 2≤l≤L−1. Each neuron model 300 in the (l−1)th layer corresponds to the neuron model 300 that outputs a spike to each neuron model 300 in the l-th layer.

The L-th layer corresponds to an example of an output layer. The neuron models 300 in the L-th layer output an output signal of the spiking neural network 200 in response to spikes from the neuron models 300 in the (L−1)th layer.

The number of neuron models 300 included in each layer is not limited to a specific number. Moreover each layer may include the same number of neuron models 300, or may include different numbers of neuron models 300.

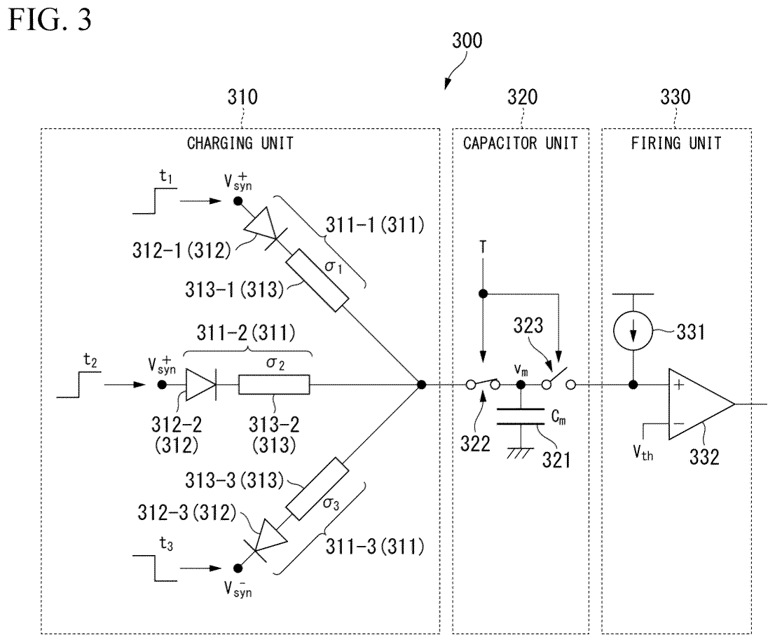

FIG. 3 is a diagram showing an example of a configuration of the neuron model 300 in a case where configured as hardware. In the example of FIG. 3, the neuron model 300 includes a charging unit 310, a capacitor unit 320, and a firing unit 330. The charging unit 310 includes a synapse unit 311 in which a diode 312 and a resistor 313 are connected in series. The capacitor unit 320 includes a capacitor 321, a charging side switch 322, and a firing side switch 323. The firing unit 330 includes a current source 331 and a comparator 332.

The spiking neural network 200 configured in hardware is also referred to as a spiking neural network circuit. The neuron model 300 configured in hardware is also referred to as a neuron model circuit.

In the example of FIG. 3, the charging unit 310 includes three synapse units 311. In a case where distinguishing between the three synapse units 311, they are also referred to as synapse units 311-1, 311-2, and 311-3. The diode 312 of synapse unit 311-1 is also referred to as diode 312-1. The resistor 313 of synapse unit 311-1 is also referred to as resistor 313-1. The diode 312 of synapse unit 311-2 is also referred to as diode 312-2.

The resistor 313 of synapse unit 311-2 is also referred to as resistor 313-2. The diode 312 of the synapse unit 311-3 is also referred to as diode 312-3. The resistor 313 of the synapse unit 311-3 is also referred to as resistor 313-3.

The resistance value of resistor 313-1 is also denoted as σ1. The resistance value of resistor 313-2 is also denoted as σ2. The resistance value of resistor 313-3 is also denoted as σ3.

However, the number of synapse units 311 included in the neuron model 300 is not limited to a specific number. The neuron model 300 includes synapse units 311 equal to the number of neuron models 300, that output spikes to the neuron model 300, and one synapse unit 311 receives a spike input from one neuron model 300.

In the synapse unit 311, the diode 312 and the resistor 213 are connected in series. One end of the synapse unit 311 receives input of a step signal whose voltage value changes at the firing time of the neuron model 300 that outputs the spike. This end is also called the first end of the synapse unit 311.

The step signal input to the first end of the synapse unit 311 has a voltage of 0 before the firing time, and at the firing time the voltage changes from 0 to either V_{syn}⁺ or V_{syn}⁻. V_{syn}⁺ is a constant such that V_{syn}⁺>0. V_{syn}⁻ is a constant such that V_{syn}⁻<0. After the firing time, the voltage of the step signal input to the first end maintains either V_{syn}⁺ or V_{syn}⁻, which changed at the firing time.

The potential of the first end of the synapse unit 311 is the same as the voltage of the step signal input to that first end.

The first end of the synapse unit 311 may be connected to a voltage source that changes the voltage at the firing time of the neuron model 300 that outputs the spike.

The combination of whether the voltage of the step signal received by the first end of the synapse unit 311 is V_{syn}⁺ or V_{syn}⁻, and the resistance value of the resistor 313, corresponds to a weight by which the input signal of the neuron model is multiplied.

Whether a step signal of voltage V_{syn}⁺ or V_{syn}⁻ is input to the first end of the synapse unit 311, and the resistance value of the resistor 313, are determined during learning of the spiking neural network 200. Therefore, in the spiking neural network 200 after learning, the voltage of the step signal input to the first end is specified to be either 0 to V_{syn}⁺ or 0 to V_{syn}⁻ for each synapse unit 311. Moreover in the spiking neural network 200 after learning, the resistance value of the resistor 313 is fixed to a constant value for each synapse unit 311.

The diode 312 is oriented so as to block the flow of current at a time prior to the firing time of the neuron model 300 that is the source of the spike output. The diode 312 can be considered to be oriented so as to prevent reverse current flow.

Of the two ends of the synapse unit 311, the end opposite the first end is connected to the charging side switch 322 of the capacitor unit 320. This end is also referred to as the second end.

One end of the capacitor 321 is grounded (GND). This end is also referred to as the first end of the capacitor 321. The potential at the first end of the capacitor 321 is the reference potential, which is potential zero.

Of the two ends of the capacitor 321, the end opposite to the first end is connected to the charging side switch 322 and the firing side switch 323. This end is also referred to as the second end of the capacitor 321. The potential of the second end of the capacitor 321 is also denoted as vₘ. This potential vₘ is used as the membrane potential. The voltage of the capacitor 321 can be expressed as vₘ.

The capacitance of the capacitor 321 is also denoted as Cm.

One end of the charging side switch 322 is connected to the second ends of the synapse units 311. This end is also referred to as the first end of the charging side switch 322.

Of the two ends of the charging side switch 322, the end opposite to the first end is connected to the second end of the capacitor 321. This end is also referred to as the second end of the charging side switch 322.

One end of the firing side switch 323 is connected to the second end of the capacitor 321. This end is also referred to as the first end of the firing side switch 323.

The end opposite to the first end of the two ends of the firing side switch 323 is connected to the current source 331 and the comparator 332. This end is also referred to as the second end of the firing side switch 323.

The current source 331 supplies a direct current of a constant current value. In particular, the current source 331 is connected to the capacitor 321 via the firing side switch 323, and supplies a current to the capacitor 321 in a case where the firing side switch 323 is on (closed).

The comparator 332 has a first input end and a second input end, and outputs a spike in a case where the potential of the first input end is higher than the potential of the second input end. In FIG. 3, the first input end is indicated by “+” and the second input end is indicated by “−”.

The first input end of the comparator 332 is connected to the capacitor 321 via the firing side switch 323, and in a case where the firing side switch 323 is on, the potential of the first input end of the comparator 332 is vₘ. Also the potential of the second input end of the comparator 332 becomes the threshold potential Vₜₕ. The comparator 332 outputs a spike at the timing in a case where the firing side switch 323 is on and the membrane potential (potential vₘ) becomes higher than the threshold potential Vₜₕ.

The neuron model 300 has a charging phase and a firing phase. The duration of the charging phase and the duration of the firing phase are set to constant durations in advance.

In the following, an example will be described in which the duration of the charging phase and the duration of the firing phase are set to the same length, and the firing phase starts immediately after the charging phase ends.

However, the duration of the charging phase and the duration of the firing phase may be set to different lengths. There may also be a period between the end of the charging phase and the start of the firing phase.

In the charging phase, the charging side switch 322 is switched on and the firing side switch 323 is switched off (open), forming a charging circuit with the charging section 310 and the capacitor section 320. At the start of the charging phase, the membrane potential is zero. During the charging phase, the membrane potential (potential vₘ) changes over time depending on the firing state of the neuron model 300 that is the output source of the spike.

For example, the firing phase of the (l−1)th layer and the charging phase of the l-th layer may coincide in time, and the neuron model 300 of the l-th layer may receive a spike input from the neuron model 300 of the (l−1)th layer in the charging phase.

Specifically, from the synapse section 311, whose first end potential is V_{syn}⁺, a current of (V_{syn}⁺−vₘ)/σ, which is the voltage (V_{syn}⁺−vₘ) obtained by subtracting the potential vm from the potential V_{syn}⁺, divided by the resistance value σ of the resistor 313, flows to the capacitor 321. Here, in the charging phase, the only power source that charges and discharges the capacitor 321 is the synapse unit 311, so V_{syn}⁺>vₘ and V_{syn}⁺−vₘ>0.

For the synapse unit 311, where the potential of the first end is V_{syn}⁻, V_{syn}⁻<vₘ and V_{syn}⁻−vₘ<0. Therefore, a current of magnitude |(V_{syn}⁻−vₘ)/σ| where the voltage (V_{syn}⁻−vₘ) obtained by subtracting the potential vₘ from the potential V_{syn}⁻ is divided by the resistance value σ of resistor 313, flows from capacitor 321 to synapse unit 311.

In addition, since diode 312 is provided, no current flows between the synapse unit 311, whose first end has a potential of 0, and capacitor 321.

The capacitor 321 is charged and discharged according to the total value of the current (V_{syn}⁺−vₘ)/σ or (V_{syn}⁻−vₘ)/σ to and from synapse unit 311. If the total value is greater than 0, capacitor 321 is charged, and if the total value is less than 0, capacitor 321 is discharged.

In the firing phase, the charging side switch 322 is switched off and the firing side switch 323 is switched on, forming a firing circuit with the capacitor section 320 and the firing section 330. In the firing phase, the neuron model 300 fires at a firing time according to the membrane potential (potential vₘ) at the end of the charging phase. Immediately after firing, the membrane potential becomes vₘ=0, and thereafter (at least during the charging phase), the membrane potential remains vₘ=0.

Specifically, if vₘ≥Vₜₕ at the end of the charging phase, the comparator 332 immediately outputs a spike. Thereby, the comparator 332 outputs a spike at the start of the firing phase.

On the other hand, if vₘ<Vₜₕ at the end of the charging phase, the capacitor 321 is charged by the current from the current source 331, and the membrane potential increases by a constant value per unit time. In other words, the membrane potential increases linearly.

However, the change in the membrane potential during the firing phase is not limited to a linear increase. As a pattern of change in the membrane potential during the firing phase, various patterns can be used in which the firing time (the time when the membrane potential reaches the threshold potential Vₜₕ) is uniquely determined according to the membrane potential at the end of the charging phase.

If the membrane potential (potential vₘ) reaches the threshold potential Vₜₕ by the end of the charging phase, the comparator 332 outputs a spike at the timing when the membrane potential reaches the threshold potential Vₜₕ. On the other hand, if the membrane potential does not reach the threshold potential Vₜₕ by the end of the charging phase, that is, if vₘ<Vₜₕ at the end of the charging phase, the comparator 332 outputs a spike at the end of the charging phase. The output of the spike in this case is also called forced firing.

In the configuration illustrated in FIG. 3, there is no need to provide the charging circuit with active elements that consume a lot of power, such as an operational amplifier or a current source. In this respect, the configuration illustrated in FIG. 3 makes it possible to reduce the power consumption of the neuron model circuit, and in turn, to reduce the power consumption of the spiking neural network circuit.

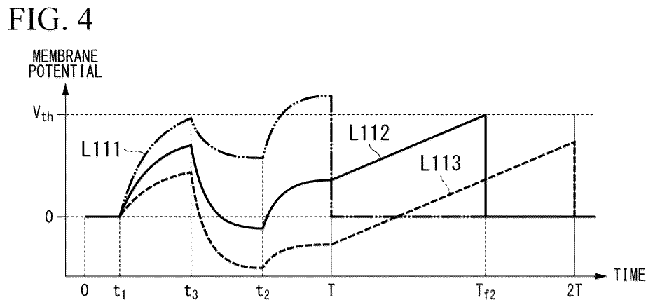

FIG. 4 is a diagram showing an example of the change in membrane potential over time. The horizontal axis of the graph in FIG. 4 indicates time. The vertical axis indicates membrane potential.

In the example in FIG. 4, the duration of the charging phase and the duration of the firing phase are both T. The start of the charging phase is indicated by time 0, and the period from time 0 to T corresponds to the charging phase, and the period from time T to 2T corresponds to the firing phase.

In the following description, in order to eliminate overlap between the charging phase and the firing phase, the time of the charging phase is set to [0, T) and the time of the firing phase is set to [T, 2T). However, time T is also referred to as the end time of the charging phase, and time 2T is also referred to as the end time of the firing phase.

FIG. 4 shows an example of the change over time in the membrane potential of the neuron model 300 in the example of FIG. 3, where the neuron model 300 receives spike inputs at times t₁, t₂, and t₃. The relationship is 0<t₁<t₃<t₂<T.

Line L111 shows an example where vₘ≥Vₜₕ at the end of the charging phase (time T). Line L112 shows an example where vₘ<Vₜₕ at the end of the charging phase, and the membrane potential (potential vₘ) reaches the threshold potential Vₜₕ by the end of the firing phase. Line L113 shows an example where vₘ<Vₜₕ at the end of the charging phase, and vₘ<Vₜₕ at the end of the firing phase.

For all of lines L111, L112, and L113, the membrane potential is zero from time 0, which is the start of the charging phase, to time t₁, in a case where the neuron model 300 receives the first spike input.

At time t₁, the potential of synapse 311-1 changes from 0 to V_{syn}⁺, and the membrane potential increases from time t₁ to t₃.

At time t₃, the potential of synapse 311-3 changes from 0 to V_{syn}⁻, and the membrane potential decreases from time t₃ to t₂.

At time t₂, the potential of synapse 311-2 changes from 0 to V_{syn}⁺, and the membrane potential increases from time t₂ to time T, which is the end of the charging phase.

In the example of line L111, vₘ≥Vₜₕ at time T, which is the end of the charging phase, and the neuron model 300 fires at the start of the firing phase (time T). The firing of the neuron model 300 causes the membrane potential to become 0, and the membrane potential remains 0 from time T until time 2T.

In the example of line L112, vₘ<Vₜₕ at time T, which is the end of the charging phase, and the membrane potential increases linearly from time T until time T_{f2}, when the membrane potential reaches the threshold potential Vₜₕ. The neuron model 300 fires at time T_{f2}, when the membrane potential reaches the threshold potential Vₜₕ. The firing of the neuron model 300 causes the membrane potential to become 0, and the membrane potential remains 0 from time T_{f2} until time 2T.

In the example of line L113, vₘ<Vₜₕ at time T, which is the end of the charging phase, and the membrane potential increases linearly from time T to time 2T, which is the end of the firing phase. At time 2T, vₘ<Vₜₕ is also true, and the neuron model 300 is firing. Due to the firing of the neuron model 300, the membrane potential becomes 0 at time 2T.

In order to calculate the firing time of the neuron model 300, the learning device 100 calculates the membrane potential at the end of the charging phase.

One method for calculating the membrane potential at the end of the charging phase is to calculate the membrane potential for each input time of a spike (input spike time) to the neuron model that is the target of membrane potential calculation.

However, if the calculation of the membrane potential is somewhat complicated and there are a large number of neuron models that are the source of spike output, it is considered that the calculation time will be long if the membrane potential is calculated for each input time of a spike.

Here, the time change in the membrane potential of the neuron model 300 in the charging phase depends on the potential difference between the potential at the first end of the synapse 311 and the membrane potential. In a case where the capacitor 321 is charged and discharged and the membrane potential changes, the potential difference between the potential at the first end of the synapse 311 and the membrane potential also changes, and the membrane potential changes nonlinearly as in the example of FIG. 4. In a case where the learning device 100 calculates the firing time of the neuron model 300 using a mathematical model, it is necessary to perform a complex calculation at this point.

Furthermore, the number of neuron models 300 included in the spiking neural network to be learned by the learning device 100 is not limited to a specific number, and may include a large number of neuron models 300. For example, in a case where the learning device 100 learns a fully connected feedforward spiking neural network including 1000 neuron models 300 in each layer, the number of neuron models 300 that are the output sources of spikes is 1000.

In this way, if the learning device 100 were to calculate the membrane potential at each timing when the neuron model 300 receives a spike input, it would take a long time to calculate the membrane potential at the end of the charging phase.

Therefore, the learning device 100 converts the spike input time into a value at a discretized time. This allows the learning device 100 to calculate the membrane potential at each discretized time. It is expected that the learning device 100 can calculate the firing time of the neuron model 300 in a shorter time, because the number of discretized times to be used for calculating the membrane potential is smaller than the number of neuron models 300 that output the spikes.

The discretized time is also called the discrete time.

In the configuration of FIG. 1, the communication unit 110 communicates with other devices. For example, the communication unit 110 may receive a mathematical model of the spiking neural network 200 (the spiking neural network to be learned) from a device that stores design information for the spiking neural network. The mathematical model referred to here is a model that expresses the behavior of the object being modeled in mathematical terms.

The display unit 120 has a display screen, such as a liquid crystal panel or an LED (Light Emitting Diode) panel, and displays various images. For example, the display unit 120 may display the progress and results of the learning of the spiking neural network.

The operation input unit 130 has input devices, such as a keyboard and a mouse, and receives user operations. For example, the operation input unit 130 may receive user operations for making various settings related to the learning of the spiking neural network, such as the learning rate.

The storage unit 180 stores various data. For example, the storage unit 180 may store the mathematical model of the spiking neural network 200 and various settings related to the learning of the spiking neural network. The storage unit 180 is configured using a storage device provided in the learning device 100.

The control unit 190 controls various parts of the learning device 100 to perform various processes. The functions of the control unit 190 may be performed by the CPU (Central Processing Unit) of the learning device 100 reading and executing a program from the storage unit 180.

The mathematical model calculation unit 191 performs calculations by the spiking neural network 200, using a mathematical model of the spiking neural network 200.

The mathematical model calculation unit 191 corresponds to an example of an output value calculation means in that it calculates the output value of the spiking neural network 200.

The discretization unit 192 converts the input time of each spike input to the neuron model 300, into a value at a discrete time. Specifically, the discretization unit 192 calculates the value of the input signal at a discrete time based on the length of time between the input time of the spike and the discrete time.

The process of converting the input time of a spike into a value at a discrete time is also called spike discretization processing.

The spike discretization process can be said to be a process in which the discretization unit 192 allocates spikes in continuous time to times in discrete time in proportion to each other. Here continuous time is time represented by continuous variables, and discrete time is time represented by discrete variables. Discrete time corresponds to time in discrete time.

The spike discretization process can also be considered as a process of converting spikes, which indicate the state of firing or not firing, into quantitative information for each discrete time.

The discretization unit 192 corresponds to an example of a discretization means.

The value at the discrete time into which the input time of a spike is converted, is also called a discrete-time input value.

The membrane potential calculation unit 193 calculates the membrane potential of the spiking neuron model at the discrete time, based on the discrete-time input value calculated by the discretization unit 192. Specifically, the membrane potential calculation unit 193 calculates the membrane potential at the next discrete time, by substituting the membrane potential at the discrete time into an equation corresponding to the discrete-time input value.

The membrane potential calculation unit 193 corresponds to an example of a membrane potential calculation means.

The firing time calculation unit 194 calculates the firing time of the neuron model 300 based on the membrane potential calculated by the membrane potential calculation unit 193. In particular, the firing time calculation unit 194 calculates the firing time based on the membrane potential at the end of the charging phase calculated by the membrane potential calculation unit 193.

The firing time calculation unit 194 corresponds to an example of a firing time calculation means.

The learning unit 195 learns the spiking neural network 200 based on the output values of the spiking neural network 200 calculated by the mathematical model calculation unit 191. In learning the spiking neural network 200, the learning unit 195 updates the values of the learning parameters of the spiking neural network 200.

The learning unit 195 corresponds to an example of a learning means.

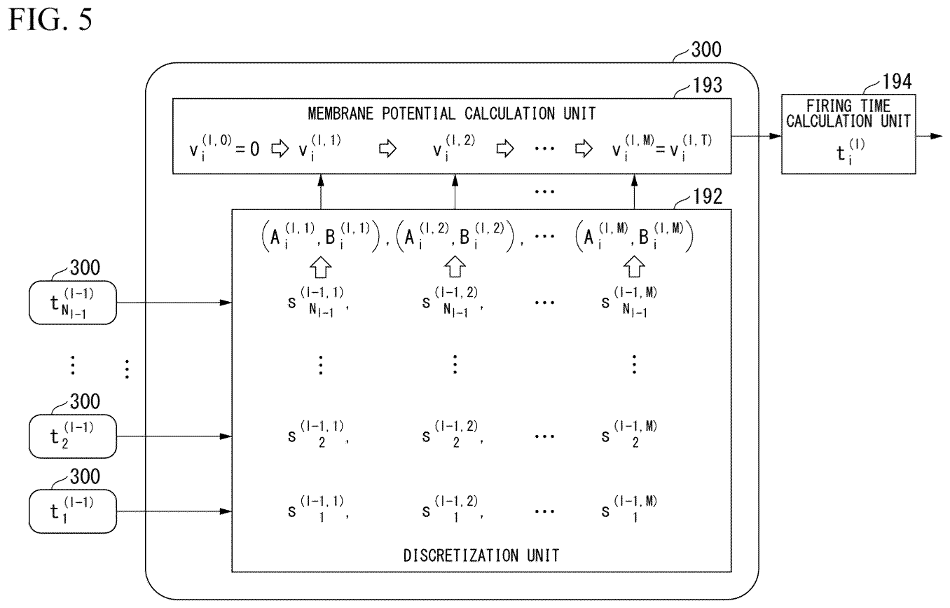

FIG. 5 is a diagram showing an example of data input/output in the learning device 100 in a case where calculating the firing time of the neuron model 300. FIG. 5 shows an example of data input/output in the learning device 100 in a case where calculating the firing time of the i-th neuron model 300 in the l-th layer of FIG. 2. Here, l is an integer such that 2≤l≤L−1. As described above, Lis an integer L≥2 that represents the number of layers in the spiking neural network 200. Here, i is an integer such that 1≤i≤N^{(l)}. N^{(l)} is an integer N^{(l)}≥1 that represents the number of neuron models 300 in the l-th layer.

In the example of FIG. 5, the discretization unit 192 converts the input time t⁽¹⁻¹⁾ⱼ of a spike from each neuron model 300 in the (l−1)th layer into a sequence of discrete-time input values s^{(l-1,1)}ⱼ, s^{(l-1,2)}ⱼ, . . . , s^{(l-1,M)}ⱼ. Here, j is an integer such that 1≤j≤N^{(l-1)}.

The sequence of discrete-time input values is also referred to as a discrete spike sequence.

The discretization unit 192 calculates the values A^{(l,m)}ᵢ and B^{(l,m)}ᵢ used in the membrane potential calculation formula for each discrete time, based on the discrete-time input value calculated for each spike input time and for each discrete time. Here, m is an integer such that 1≤m≤M. M is an integer that represents the number of discrete times for which the discrete-time input value is to be calculated, and M≥2. The value of M may be set in advance by, for example, a user.

The membrane potential calculation unit 193 calculates the membrane potential v^{(l,m)}ᵢ for each discrete time of the i-th neuron model 300 in the l-th layer. Here, m is an integer such that 1≤m≤M.

The membrane potential calculation unit 193 calculates the membrane potential v^{(l,m)}ᵢ by substituting the membrane potential v^{(l,m-1)}ᵢ and the values A^{(l,m)}ᵢ and B^{(l,m)}ᵢ calculated by the discretization unit 192 into the membrane potential calculation formula. Here, the membrane potential is defined as v^{(l,0)}ᵢ=0.

Furthermore, it is assumed that the last discrete time T^{(l,M)} among the discrete times T^{(l,1)}, T^{(l,2)}, . . . , T^{(l,M)} is the end time of the charging phase (time T). Therefore, v^{(l,m)}ᵢ=v^{(l,T)}ᵢ. Here, v^{(l,T)}ᵢ represents the membrane potential of the i-th neuron model 300 in the l-th layer at time T, which is the end time of the charging phase.

The firing time calculation unit 194 calculates the firing time based on the membrane potential v^{(l,T)}ᵢ at the end time (time T) of the charging phase calculated by the membrane potential calculation unit 193. The firing time of the i-th neuron model 300 in the l-th layer is also denoted as t^{(l)}ᵢ.

The firing time calculation unit 194 compares the membrane potential v^{(l,T)}ᵢ with the threshold potential Vₜₕ. If v^{(l,T)}ᵢ≥Vₜₕ, the firing time calculation unit 194 calculates t^{(l)}ᵢ=T. In other words, the firing time calculation unit 194 calculates the firing time as the start time of the firing phase.

On the other hand, if v^{(l,T)}ᵢ<Vₜₕ, the firing time calculation unit 194 calculates the time required (Vₜₕ−v^{(l,T)}ᵢ)/Δvₛₚ for the membrane potential to reach the threshold potential Vₜₕ, by dividing the difference obtained by subtracting the membrane potential v^{(l,T)}ᵢ at the end time (time T) of the charging phase, from the threshold potential Vₜₕ, by the rate of increase Δvₛₚ in the membrane potential in the firing phase. Then the firing time calculation unit 194 compares; the time T+(Vₜₕ−v^{(l,T)}ᵢ)/Δvₛₚ, which is obtained by adding the time required (Vₜₕ−v^{(l,T)}ᵢ)/Δvₛₚ) for the membrane potential to reach the threshold potential Vₜₕ to the start time T of the firing phase, with the end time 2T of the firing phase.

If T+(Vₜₕ−v^{(l,T)}ᵢ)/Δvₛₚ≤2T, the firing time calculation unit 194 calculates t^{(l)}ᵢ=T+(Vₜₕ−V^{(l,T)}ᵢ)/Δvₛₚ.

On the other hand, if T+(Vₜₕ−v^{(l,T)}ᵢ)/Δvₛₚ>2T, the firing time calculation unit 194 calculates t^{(l)}ᵢ=2T. That is, if the membrane potential does not reach the threshold potential Vₜₕ at the end time 2T of the firing phase, the firing time calculation unit 194 calculates the firing time t^{(l)}ᵢ to be the end time 2T of the firing phase, which is the firing time due to forced firing.

The firing time of the l-th layer neuron model 300 is used as the input time of a spike to the (l+1)th layer neuron model 300. Here, l is an integer such that 1≤l≤L−1.

When the spike input time and firing time are expressed by the time for each layer, the firing time is converted to the spike input time. For example, if the charging phase is from time 0 to T, and the firing phase is from time T to 2T, then subtracting T from the firing time of the neuron model 300 in the l-th layer converts it into the spike input time to the neuron model 300 in the (l+1)th layer.

The calculation of the firing time by the learning device 100 will be further explained using numerical formulas.

The charging phase of the neuron model 300 in the l-th layer is from time l−1 to just before time l, and the firing phase is from time l to just before l+1. Here, l is an integer such that 1≤l≤N. However, time l is referred to as the end time of the charging phase of the neuron model 300 in the l-th layer, and time l+1 is referred to as the end time of the firing phase of the neuron model 300 in the l-th layer.

In a case where the spike input time is not discretized, the time evolution of the membrane potential of the i-th neuron model 300 in the l-th layer is expressed by a differential equation such as expression (1).

$$\frac{d}{dt} {ν}_{i}^{( l 〉} ( t ) = \{ \begin{matrix}{\sum }_{j = 1}^{{M}^{( l - 1 )}} {w}_{i , j}^{( l )} ( 1 - {v}_{i}^{( l )} {β}_{i , j}^{( l )} ) θ ( t - {t}_{j}^{( l - 1 )} ) , & for l - 1 \leq t < l \\ 1 , & for l \leq t < l + 1\end{matrix} \qquad ( 1 )$$

v^{(l)}ᵢ(t) represents the membrane potential of the i-th neuron model 300 in the l-th layer at time t. The notation of time t in “v^{(l)}ᵢ(t)” is omitted and it is also denoted as “v^{(l)}ᵢ”.

w^{(l)}_{i,j} represents the connection strength from the j-th neuron model 300 in the (l−1)th layer to the i-th neuron model 300 in the l-th layer. In other words, w^{(l)}_{i,j} represents the weight multiplied by the spike input from the j-th neuron model 300 in the (l−1)th layer to the i-th neuron model 300 in the l-th layer. The weight w^{(l)}_{i,j} is a learning parameter (parameter to be learned).

The variables β^{(l)}_{i,j} are defined as in expression (2).

$${β}_{i , j}^{( l )} := {β}^{+} {δ}_{{w}_{i , j}^{( l )} \geq 0} + {β}^{-} {δ}_{{w}_{i , j}^{( l )} < 0} \qquad ( 2 )$$

Both β⁺ and β⁻ are parameters that determine the nonlinearity of the membrane potential trajectory, with β⁺>0 and β⁻<0. The larger the magnitude of β⁺|β⁺|, the stronger the nonlinearity. Also, the larger the magnitude of β⁻|β⁻|, the stronger the nonlinearity. The values of these parameters are determined based on the resistive coupling effect in the hardware, and the nonideal characteristics of the current source. δw_{(l)i,j}≥0 is expressed as in expression (3).

$${δ}_{{w}_{i , j}^{( l )} \geq 0} = \{ \begin{matrix}1 , & for {w}_{i , j}^{( l )} \geq 0 \\ 0 , & for {w}_{i , j}^{( l )} < 0\end{matrix} \qquad ( 3 )$$

δ_{w(l)i,j}<0 is expressed as in expression (4).

$${δ}_{{w}_{i , j}^{( l )} < 0} = \{ \begin{matrix}1 , & for {w}_{i , j}^{( l )} < 0 \\ 0 , & for {w}_{i , j}^{( l )} \geq 0\end{matrix} \qquad ( 4 )$$

θ is a step function, expressed as in expression (5).

$$θ ( t ) = \{ \begin{matrix}0 , & for t < 0 \\ 1 , & for t \geq 0\end{matrix} \qquad ( 5 )$$

In the charging phase (l−1≤t<1), the membrane potential evolves nonlinearly over time, as in exponential decay of membrane potential (exponential decay) or attenuation of RC circuits (RC-decay).

Here, the input spikes {t^{(l-1)}ᵢ}_{i=1, 2 . . . , N(l-1)} rearranged in ascending order are denoted as {t^{\hat{ }(l-1)}ᵢ}_{i=1, 2, . . . , N(l-1)}. Moreover, the corresponding rearranged weights are denoted as {w^{\hat{ }}_{i,j}}_{i=1, 2, . . . , N(l-1)}.

The time evolution of the membrane potential can be expressed as shown in expression (6).

$${ν}_{i}^{( l , q )} = \frac{{A}_{i , q}^{( l )}}{{B}_{i , q}^{( l )}} - ( \frac{{A}_{i , q}^{( l )}}{{B}_{i , q}^{( l )}} - {v}_{i}^{( l , q - 1 )} ) exp ( - {B}_{i , q}^{( l )} Δ {\hat{t}}_{q}^{( l - 1 )} ) \qquad ( 6 )$$

Here, q is an integer such that l≤q≤N^{(l-1)}.

In a case where q<N^{(l-1)}, v^{(l,q)}ᵢ represents the membrane potential at time t=t^{\hat{ }(l-1)}_{q+1} when the i-th neuron model 300 in the l-th layer receives the (q+1)th input spike. Since the membrane potential is 0 from the start of the charging phase until the neuron model 300 receives the first input spike, v^{(l,1)}ᵢ=0 is defined.

In a case where q=N^{(l-1)}, v^{(l,q)}ᵢ represents the membrane potential of the i-th neuron model 300 in the l-th layer, at the final time t=1 of the charging phase.
exp represents the power of Napier's number.
A^{(l)}_{i,q} is expressed as in expression (7).

$${A}_{i , q}^{〈 l )} = {\sum }_{j = 1}^{q} {\hat{w}}_{i , j}^{( t )} \qquad ( 7 )$$

B^{(l)}_{i,q} is expressed as in expression (8).

$${B}_{i , q}^{( l )} = {\sum }_{j = 1}^{q} {\hat{w}}_{i , j}^{( l )} {β}_{i , j}^{( l )} \qquad ( 8 )$$

Δt^{\hat{ }(l-1)}_{q} is expressed as in expression (9).

$$Δ {\hat{t}}_{q}^{( l - 1 )} = \{ \begin{matrix}{\hat{t}}_{q + 1}^{( l - 1 )} - {\hat{t}}_{q}^{( l - 1 )} & for q < {N}^{( l - 1 )} \\ l - {\hat{t}}_{q}^{( l - 1 )} , & for q = {N}^{( l - 1 )}\end{matrix} \qquad ( 9 )$$

The firing time t^{(l)}ᵢ of the i-th neuron model 300 in the l-th layer is expressed as in expression (10), based on the membrane potential v^{(l,N(l))}ᵢ at the final time of the charging phase.

$${t}_{i}^{( l )} = l + 1 - {v}_{i}^{( l , {N}^{( l )} )} \qquad ( 10 )$$

If the learning device 100 were to calculate the firing time based on expressions (6) to (10), it would be necessary to perform a power calculation for each input spike time, which would increase the amount of calculation. In particular, it is considered that the greater the number of neuron models 300 included in each layer, the greater the amount of calculation required to calculate the firing times, and the longer the calculation time.

Therefore, we consider discretizing the input spike time.

The discrete time sequence T^{(l,1)}, T^{(l,2)}, . . . , T^{(l,M)} of the l-th layer is defined as in expression (11).

$${T}^{( l , m )} = l + 1 ( m - 1 ) Δ t - {t}_{offset}^{( l )} , ( m = 1 , … , M ) \qquad ( 11 )$$

M is an integer M≥2 that represents the number of discrete times.
Δt is a constant Δt>0 that represents the discrete time step.
t^{(l)}_{offset} is an offset time provided for each layer to prevent a decrease in learning accuracy due to repeated learning using a specific discrete time sequence. It has been found that in a case where the offset time t^{(l)}_{offset} is not provided, the recognition accuracy (estimation accuracy) of the spiking neural network 200 during training is high, while the recognition accuracy of the spiking neural network 200 during testing is low. This is thought to be because the learning device 100 has over-learned the time-discretized model.

The value of the offset time t^{(l)}_{offset} is set randomly within the range of expression (12) for each step of repetition in machine learning, such as for each mini-batch in mini-batch learning.

$$0 \leq {t}_{offset}^{( l )} < Δ t \qquad ( 12 )$$

In the following, an example will be described in which the time Δt is the time obtained by dividing the duration of the charging phase (the time from the start time to the end time of the charging phase) by the number of discrete time intervals (M−1).

However, various times can be used as the time Δt and the offset time t^{(l)}_{offset} such that the discrete time T^{(l,M)} is the end time of the charging phase or a time before that.

Let U^{(l-1)}ₘ be the index set of the (l−1)th layer neuron model 300 that fires at a certain time T^{(l,m)}, and define the union U^{\hat{ }(l-1)}ₘ of its disjoint sets as shown in expression (13).

$${\hat{U}}_{m}^{( l - 1 )} := {⋃}_{q = 0}^{m} {U}_{q}^{( l - 1 )} \qquad ( 13 )$$

Here, m is an integer such that 0≤m≤M−1.

U^{\hat{ }(l-1)}ₘ is the set of indices of input spikes that arrive up to time T^{(l,m)} (including time T^{(l,m)}).

The time evolution of the membrane potential of the i-th neuron model 300 in the l-th layer at time [T^{(l,m)}, T^{(l,m+1)}] can be expressed as in expression (14).

$$\frac{d}{d t} {v}_{i}^{( l )} ( t ) = {\sum }_{{j = 1}^{}}^{{N}^{( l - 1 )}} {w}_{i , j}^{( l )} {S}_{j}^{( 1 - 1 , m )} ( 1 - {v}_{i}^{( l )} {β}_{i , j}^{( l )} ) , {T}^{( l , m )} \leq t \leq {T}^{( l , M + 1 )} \qquad ( 14 )$$

S^{(l-1,m)}ⱼ is shown as in expression (15).

$${S}_{j}^{( l - 1 , m )} = {\sum }_{q = 0}^{m} {s}_{j}^{( l - 1 , q )} \qquad ( 15 )$$

s^{(l-1,q)}ⱼ is shown as in expression (16).

$${s}_{j}^{( l - 1 , q )} = \{ \begin{matrix}1 , & for j ∈ {U}_{q}^{( l - 1 )} \\ 0 , & for j ∉ {U}_{q}^{( l - 1 )}\end{matrix} \qquad ( 16 )$$

Expression (14) can be solved analytically as in expression (17).

$${v}_{i}^{( l , m )} = \{ \begin{matrix}\frac{{A}_{i}^{( l , m )}}{{B}_{i}^{( l , m )}} - ( \frac{{A}_{i}^{( l , m )}}{{B}_{i}^{( l , m )}} - {v}_{i}^{( l , m - 1 )} ) exp ( - {B}_{i}^{( l , m )} Δ t ) , & for m < M \\ \frac{{A}_{i}^{( l , m )}}{{B}_{i}^{( l , m )}} - ( \frac{{A}_{i}^{( l , m )}}{{B}_{i}^{( l , m )}} - {v}_{i}^{( l , m - 1 )} ) exp ( - {B}_{i}^{( l , m )} {t}_{offset}^{( l )} ) , & for m = M\end{matrix} \qquad ( 17 )$$

Here too, v^{(l,0)}ᵢ=0 is defined.

A^{(l,m)}ᵢ is expressed as in expression (18).

$${A}_{i}^{( l , m )} = {\sum }_{j = 1}^{{N}^{( l - 1 )}} {w}_{i , j}^{( l )} {S}_{j}^{( l - 1 , m )} \qquad ( 18 )$$

B^{(l,m)}ᵢ is expressed as in expression (19).

$${B}_{i}^{( l , m )} = {\sum }_{j = 1}^{{N}^{( l - 1 )}} {w}_{i , j}^{( l )} {β}_{i , j}^{( l )} {S}_{j}^{( l - 1 , m )} \qquad ( 19 )$$

Expression (17) corresponds to an example of an equation corresponding to a discrete-time input value. That is, expression (17) is an equation for calculating the membrane potential v^{(l,m)}ᵢ using values A^{(l,m)}ᵢ and B^{(l,m)}ᵢ calculated according to the discrete-time input value, as in expressions (18) and (19).

Firing time t^{(l)}ᵢ is expressed as in expression (20).

$${t}_{i}^{( l )} = l + 1 - {v}_{i}^{( l , M )} \qquad ( 20 )$$

In this way, in a case where all input spikes exist only in a specific time sequence {T^{(l,m)}}_{m=1, . . . , M}, the membrane potential value at the end of the charging phase can be obtained by M sequential calculations.

Then, the discretization unit 192 converts the input spikes t^{(l-1)}₁, t^{(l-1)}₂, t^{(l-1)}₃, . . . , t^{(l-1)}_{M} into a discrete spike sequence as shown in expression (2l).

$$\{ {s}_{j}^{( l - 1 , 1 )} , {s}_{j}^{( l - 1 , 2 )} , … , {s}_{j}^{( l - 1 , M )} \} = Discretize ( {t}_{j}^{( l - 1 )} ) \qquad ( 21 )$$

Discretize is a function that converts the input spike time t^{(l-1)}ⱼ into a discrete spike sequence s^{(l-1,1)}ⱼ, s^{(l-1,2)}ⱼ, . . . , s^{(l-1,M)}ⱼ. A discrete spike sequence is a sequence of discrete-time input values associated with discrete times T^{(l,1)}, T^{(l,2)}, . . . , T^{(l,M)}.

As described above, the discretization unit 192 can be considered to convert, through this conversion, an input spike that is input at any time during the charging phase and indicates the state of the spike output source neuron model 300, i.e., whether or not it fires, into a time series of discrete-time input values that are input at specified discrete times and take real values. In particular, in expression (16), the input spike s^{(l-1,q)}ⱼ takes the value 0 or 1, whereas in expression (21), the discrete-time input value s^{(l-1,m)}ⱼ takes a real value.

In the following, the subscripted variable s represents the discrete-time input value. Therefore, the subscripted variable s takes a real value.

The discretization unit 192 converts the input spike time into a discrete spike sequence, for example, based on expression (22).

$${s}_{j}^{( l - 1 , m )} = \{ \begin{matrix}max ( 0 , \frac{Δ t - \vert {T}^{( l , m )} - {t}_{j}^{( l - 1 )} \vert}{Δ t} ) , & for {t}_{i}^{( l )} \leq {T}^{( l , m )} \\ max ( 0 , \frac{{t}_{offset}^{( l )} - \vert {T}^{( l , m )} - {t}_{j}^{( l - 1 )} \vert}{{t}_{offset}^{( l )}} ) , & for {t}_{i}^{( l )} > {T}^{( l , m )}\end{matrix} \qquad ( 22 )$$

The learning device 100 can calculate the firing time t^{(l)}ᵢ using expressions (15) and (17) to (20), by replacing the input spike s^{(l-1,q)}ⱼ with the discrete-time input value s^{(l-1,m)}ⱼ.

Specifically, the discretization unit 192 calculates S^{(l-1,m)}ⱼ by substituting the discrete-time input value s^{(l-1,m)}ⱼ calculated for each input spike and for each discrete time into the above expression (15). Then the discretization unit 192 substitutes the calculated S^{(l-1,m)}ⱼ into the above expressions (18) and (19) to calculate A^{(l,m)}ᵢ and B^{(l,m)}ᵢ.

The membrane potential calculation unit 193 substitutes the A^{(l,m)}ᵢ and B^{(l,m)}ᵢ calculated by the discretization unit 192 into expression (17) to calculate the membrane potential v^{(l,m)}ᵢ for each discrete time in the order of m=1, 2, . . . , M.

Here too, v^{(l,0)}ᵢ=0 is defined.

The firing time calculation unit 194 calculates the firing time t^{(l)}ᵢ based on v^{(l,M)}ᵢ calculated by the membrane potential calculation unit 193. Here, the threshold potential is 1, and the firing time calculation unit 194 compares v^{(l,M)}ᵢ with 1.

If v^{(l,M)}ᵢ≥1, the firing time calculation unit 194 calculates t^{(l)}ᵢ=1. That is, the firing time calculation unit 194 calculates the firing time as the start time of the firing phase.

On the other hand, if v^{(l,M)}ᵢ<1, the firing time calculation unit 194 calculates the time l+1−v^{(l,M)}ᵢ at which the membrane potential reaches the threshold potential. If l+1−v^{(l,M)}ᵢ≤2l, the firing time calculation unit 194 calculates t^{(l)}ᵢ=l+1−v^{(l,M)}ᵢ, as shown in expression (20).

On the other hand, if l+1−v^{(l,M)}ᵢ>2l, the firing time calculation unit 194 calculates t^{(l)}ᵢ=2l. That is, the firing time calculation unit 194 calculates the firing time t^{(l)}ᵢ as the end time 2l of the firing phase, which is the firing time due to forced firing.

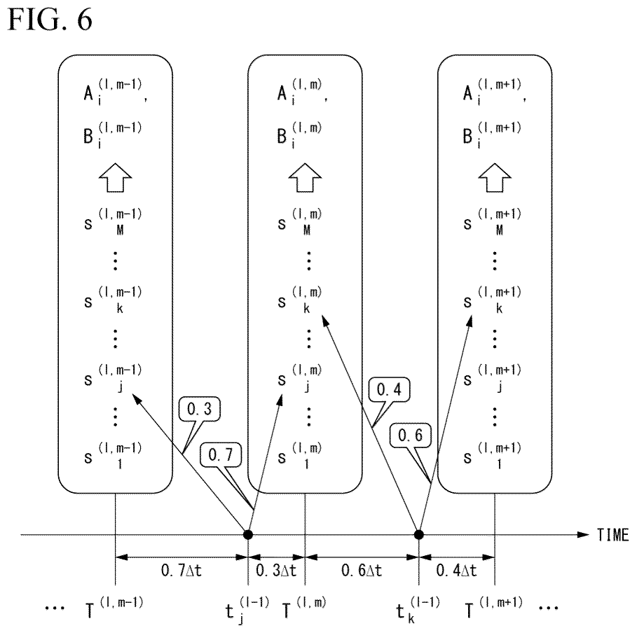

FIG. 6 is a diagram showing an example of the process in which the discretization unit 192 converts an input spike time into a discrete spike sequence. FIG. 6 shows an example of the case in which the discretization unit 192 converts an input spike time into a discrete spike sequence based on expression (22).

The horizontal axis of the graph in FIG. 6 represents time.

In the example of FIG. 6, the discretization unit 192 assigns values of 0.3 and 0.7 to the discrete time T^{(l,m-1)} immediately before the input spike time t^{(l-1)}ⱼ, and the discrete time T^{(l,m)} immediately after it, among the discrete times T^{(l,1)}, T^{(l,2)}, . . . , T^{(l,M)}, in accordance with the inverse ratio of the ratio 0.7Δt:0.3Δt of the distance between the discrete time and the input spike time.

The discretization unit 192 also assigns values of 0.4 and 0.6 to the discrete time T^{(l,m)} immediately before the input spike time t^{(l-1)}ₖ, and the discrete time T^{(l,m+1)} immediately after it, in accordance with the inverse ratio of the ratio 0.6Δ:0.4Δt of the distance between the discrete time and the input spike time.

In this way, in a case where based on expression (22), the discretization unit 192, among the discrete times, assigns discrete-time input values to the time immediately before the input spike time, and the time immediately after the input spike time, in accordance with the proportion of the inverse ratio of the length of time from the time immediately before the input spike time to the input spike time, to the length of time from the input spike time to the time immediately after the input spike time.

Among the discrete times, the time immediately before the input spike time, is also referred to as the first time. Among the discrete times, the time immediately after the input spike time, is also referred to as the second time. The time from the first time to the input spike time is also referred to as the first time. The time from the input spike time to the second time is also referred to as the second time.

In a case where the discretization unit 192 discretizes the input spike time based on expression (22), the discrete-time input value s^{(l-1,m)}ⱼ changes continuously with respect to the change in the input spike time t^{(l-1)}ⱼ, and the discrete-time input value s^{(l-1,m)}ⱼ is differentiable with respect to the input spike time t^{(l-1)}ⱼ except when t^{(l-1)}ⱼ=T^{(l,m)}.

This enables the learning device 100 to learn the spiking neural network 200 using a learning algorithm that uses differentiation, such as backpropagation.

Next, the results of an experiment on the learning of the spiking neural network 200 by the learning device 100 will be described.

In the experiment, the Fashion-MNIST dataset was used as training data. The network structure was a fully connected feedforward multilayer network. The number of nodes was 784 for the input layer, 400 for the first hidden layer, 400 for the second hidden layer, and 10 for the output layer.

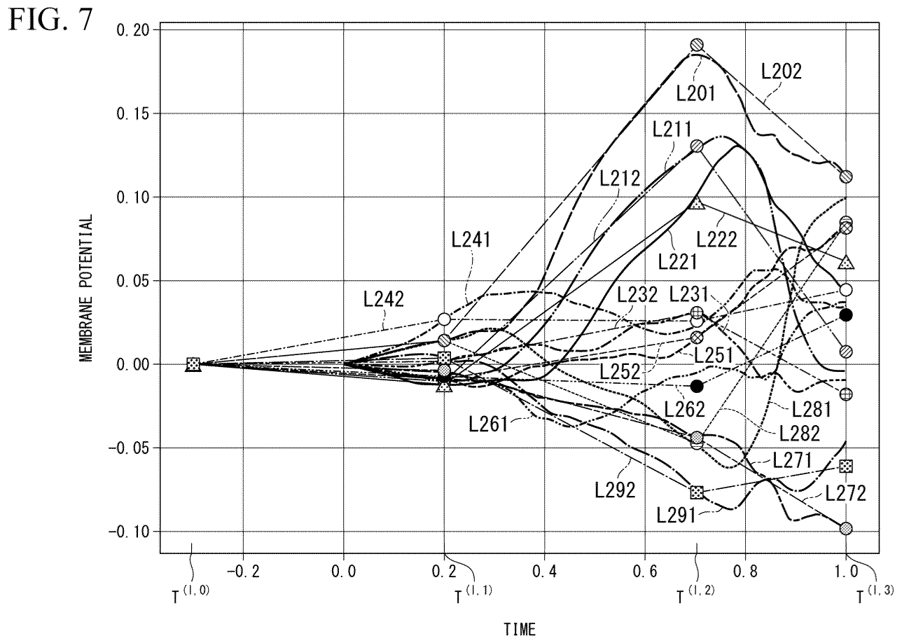

FIG. 7 is a diagram showing an example of experimental results of the membrane potential calculated by the learning device 100, in a case where the number of discrete times for which the membrane potential is calculated is three. The horizontal axis of the graph in FIG. 7 represents time, and the vertical axis represents the membrane potential. In FIG. 7, the start time of the charging phase is time 0, and the end time of the charging phase is time 1.

Line L201 shows a first example of a membrane potential trajectory in a case where the membrane potential is calculated without discretizing the input spike time. Line L202 shows an example of a membrane potential trajectory in a case where the membrane potential is calculated by discretizing the input spike time, for the example shown by line L201. Line L211 shows a second example of a membrane potential trajectory in a case where the membrane potential is calculated without discretizing the input spike time. Line L212 shows an example of a membrane potential trajectory in a the example shown by line L211.

Line L221 shows a third example of a membrane potential trajectory in a case where the membrane potential is calculated without discretizing the input spike time. Line L222 shows an example of a membrane potential trajectory in a case where the membrane potential is calculated by discretizing the input spike time, for the example shown by line L221. Line L231 shows a fourth example of a membrane potential trajectory in a case where the membrane potential is calculated without discretizing the input spike time. Line L232 shows an example of a membrane potential trajectory in a case where the membrane potential is calculated by discretizing the input spike time, for the example shown by line L231.

Line L241 shows a fifth example of a membrane potential trajectory in a case where the membrane potential is calculated without discretizing the input spike time. Line L242 shows an example of a membrane potential trajectory in a case where the membrane potential is calculated by discretizing the input spike time, for the example shown by line L241. Line L251 shows a sixth example of a membrane potential trajectory in a case where the membrane potential is calculated without discretizing the input spike time. Line L252 shows an example of a membrane potential trajectory in a the example shown by line L251.

Line L261 shows a seventh example of a membrane potential trajectory in a case where the membrane potential is calculated without discretizing the input spike time. Line L262 shows an example of a membrane potential trajectory in a case where the membrane potential is calculated by discretizing the input spike time, for the example shown by line L261. Line L271 shows an eighth example of a membrane potential trajectory in a case where the membrane potential is calculated without discretizing the input spike time. Line L272 shows an example of a membrane potential trajectory in a case where the membrane potential is calculated by discretizing the input spike time, for the example shown by line L271.

Line L281 shows a ninth example of a membrane potential trajectory in a case where the membrane potential is calculated without discretizing the input spike time. Line L282 shows an example of a membrane potential trajectory in a case where the membrane potential is calculated by discretizing the input spike time, for the example shown by line L281. Line L291 shows a tenth example of a membrane potential trajectory in a case where the membrane potential is calculated without discretizing the input spike time. Line L292 shows an example of a membrane potential trajectory in a the example shown by line L291.

Due to the setting of the offset time T^{(l)}_{offset}, the discrete time T^{(l,0)} is a time before time 0. As described above, the membrane potential v^{(l,0)}ᵢ at the discrete time T^{(l,0)} is set to 0. Also, the discrete time T^{(l,3)} is time 1, that is, the end time of the charging phase.

In the calculation of the membrane potential in a case where the input spike times are discretized, the membrane potential v^{(l,m)}ᵢ is calculated based on the membrane potential v^{(l,m-1)}ᵢ. In the example of FIG. 7, m=1, 2, 3.

In the example of FIG. 7, even when the number of discrete times for which the membrane potential is calculated is three, the membrane potential at the end of the charging phase can be calculated with high accuracy, and it is expected that the firing time can be calculated with high accuracy.

In particular, in the examples of lines L202, L252, and L272, the membrane potential at the end of the charging phase in a case where the input spike time is discretized is almost the same as the membrane potential at the end of the charging phase in a case where the input spike time is not discretized.

FIG. 8 shows an example of the experimental results of the membrane potential calculated by the learning device 100, in a case where the number of discrete times for which the membrane potential is calculated is five. The horizontal axis of the graph in FIG. 8 represents time, and the vertical axis represents membrane potential. In FIG. 8, the start time of the charging phase is time 0, and the end time of the charging phase is time 1.

Lines L301 to L391 are similar to lines L201 to L291 in FIG. 7. Line L302 shows an example of a membrane potential trajectory in a case where the membrane potential is calculated by discretizing the input spike time, for the example shown by line L301.

Line L312 shows an example of a membrane potential trajectory in a case where the membrane potential is calculated by discretizing the input spike time, for the example shown by line L311.

Line L322 shows an example of a membrane potential trajectory in a case where the membrane potential is calculated by discretizing the input spike time, for the example shown by line L321.

Line L332 shows an example of a membrane potential trajectory in a case where the membrane potential is calculated by discretizing the input spike time, for the example shown by line L331.

Line L342 shows an example of the membrane potential trajectory in a case where the membrane potential is calculated by discretizing the input spike time, for the example shown by line L341.

Line L352 shows an example of the membrane potential trajectory in a case where the membrane potential is calculated by discretizing the input spike time, for the example shown by line L351.

Line L362 shows an example of the membrane potential trajectory in a case where the membrane potential is calculated by discretizing the input spike time, for the example shown by line L361.

Line L372 shows an example of the membrane potential trajectory in a case where the membrane potential is calculated by discretizing the input spike time, for the example shown by line L371.

Line L382 shows an example of the membrane potential trajectory in a case where the membrane potential is calculated by discretizing the input spike time, for the example shown by line L381.

Line L392 shows an example of the membrane potential trajectory in a case where the membrane potential is calculated by discretizing the input spike time, for the example shown by line L391.

In the example of FIG. 8, due to the setting of the offset time T^{(l)}_{offset}, the discrete time T^{(l,0)} is a time before time 0. As described above, the membrane potential v^{(l,0)}ᵢ at discrete time T^{(l,0)} is set to 0. Also, the discrete time T^{(l,5)} is time 1, that is, the end time of the charging phase.

In the calculation of the membrane potential in a case where the input spike times are discretized, the membrane potential v^{(l,m)}ᵢ is calculated based on the membrane potential v^{(l,m-1)}ᵢ. In the example of FIG. 8, m=1, 2, . . . , 5.

In the example of FIG. 8, the membrane potential at the end of the charging phase can be calculated with even greater accuracy than in the example of FIG. 7, and it is expected that the firing time can be calculated with greater accuracy.

In particular, in the examples of lines L302, L332, L342, L352, L362, L372, and L382, the membrane potential at the end of the charging phase in a case where the input spike time is discretized is almost the same as the membrane potential at the end of the charging phase in a case where the input spike time is not discretized.

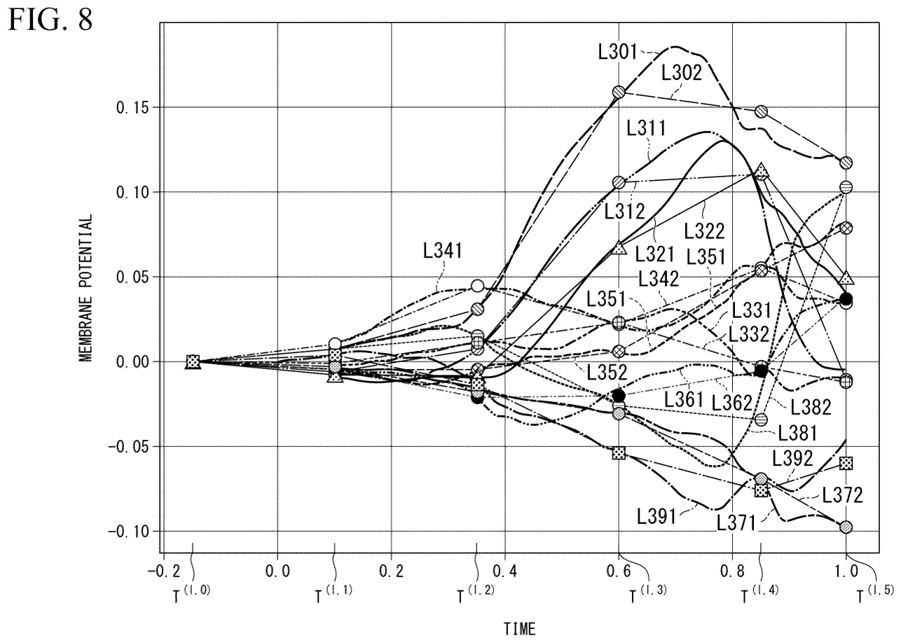

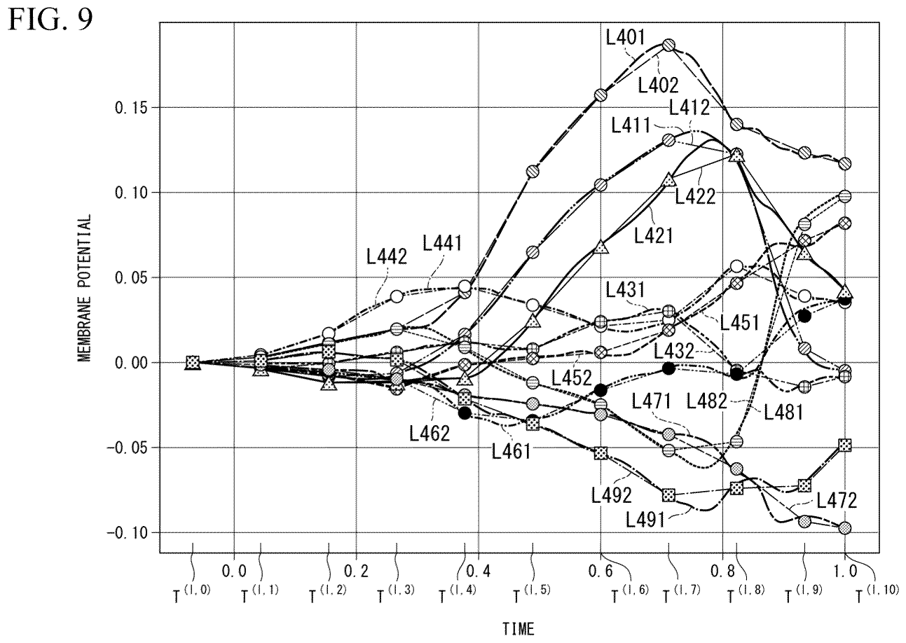

FIG. 9 is a diagram showing an example of the experimental results of the membrane potential calculated by the learning device 100, in a case where the number of discrete times for which the membrane potential is calculated is 10. The horizontal axis of the graph in FIG. 9 represents time, and the vertical axis represents membrane potential. In FIG. 9, the start time of the charging phase is time 0, and the end time of the charging phase is time 1.

Lines L401 to L491 are similar to lines L201 to L291 in FIG. 7. Line L402 shows an example of a membrane potential trajectory in a case where the membrane potential is calculated by discretizing the input spike time, for the example shown by line L401.

Line L412 shows an example of a membrane potential trajectory in a case where the membrane potential is calculated by discretizing the input spike time, for the example shown by line L411.

Line L422 shows an example of a membrane potential trajectory in a case where the membrane potential is calculated by discretizing the input spike time, for the example shown by line L421.

Line L432 shows an example of a membrane potential trajectory in a case where the membrane potential is calculated by discretizing the input spike time, for the example shown by line L431.

Line L442 shows an example of a membrane potential trajectory in a case where the membrane potential is calculated by discretizing the input spike time, for the example shown by line L441.

Line L452 shows an example of a membrane potential trajectory in a case where the membrane potential is calculated by discretizing the input spike time, for the example shown by line L451.

Line L462 shows an example of a membrane potential trajectory in a case where the membrane potential is calculated by discretizing the input spike time, for the example shown by line L461.

Line L472 shows an example of a membrane potential trajectory in a case where the membrane potential is calculated by discretizing the input spike time, for the example shown by line L471.

Line L482 shows an example of a membrane potential trajectory in a case where the membrane potential is calculated by discretizing the input spike time, for the example shown by line L481.

Line L492 shows an example of a membrane potential trajectory in a case where the membrane potential is calculated by discretizing the input spike time, for the example shown by line L491.

In the example of FIG. 9, due to the setting of the offset time T^{(l)}_{offset}, the discrete time T^{(l,0)} is a time before time 0. As described above, the membrane potential v^{(l,0)}ᵢ at discrete time T^{(l,0)} is set to 0. Also, the discrete time T^{(l,10)} is time 1, that is, the end time of the charging phase.

In the calculation of the membrane potential in a case where the input spike times are discretized, the membrane potential v^{(l,m)}ᵢ is calculated based on the membrane potential v^{(l,m-1)}ᵢ. In the example of FIG. 9, m=1, 2, . . . , 10.

In the example of FIG. 9, the membrane potential at the end of the charging phase can be calculated with even greater accuracy than in the example of FIG. 8, and it is expected that the firing time can be calculated with greater accuracy.

In particular, in each of the examples from line L402 to L492, the membrane potential at the end of the charging phase in a case where the input spike time is discretized is almost the same as the membrane potential at the end of the charging phase in a case where the input spike time is not discretized.

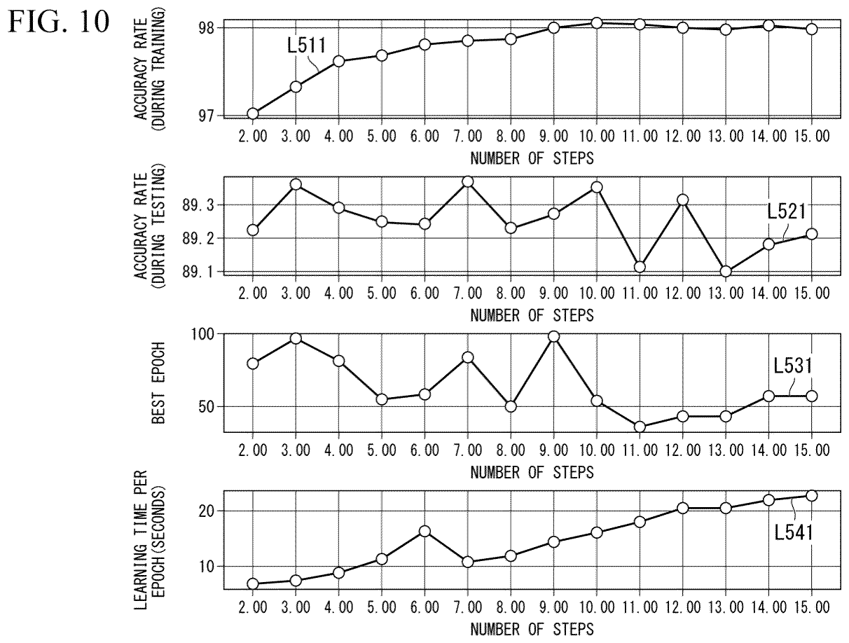

FIG. 10 shows an example of the results of learning of the spiking neural network 200 by the learning device 100. The horizontal axis of the graph in FIG. 10 shows the number of steps (number of epochs). The vertical axis shows the accuracy rate during training, the accuracy rate during testing, the best epoch (the epoch with the highest recognition performance (accuracy rate) during testing), and the learning time per epoch. The unit of learning time is seconds.

Line L511 shows the relationship between the number of steps and the accuracy rate during training.

Line L521 shows the relationship between the number of steps and the accuracy rate during testing.

Line L531 shows the relationship between the number of steps and the best epoch.

Line L541 shows the relationship between the number of steps and the learning time per epoch.

As lines L511 and L521 show, a high accuracy rate was obtained during both training and testing. Furthermore, as shown by line L541, learning could be completed in a relatively short time.

As shown in the examples of FIG. 7 to FIG. 10, the learning device 100 is expected to enable highly accurate learning of the spiking neural network 200. In particular, by the discretization unit 192 discretizing the input spike time, the membrane potential calculation unit 193 can reduce the number of times it calculates the membrane potential.

As a result, the membrane potential calculation unit 193 can analytically solve the calculation of the membrane potential using a complex equation such as expression (17), and the time required to calculate the firing time (the total time in which the discretization unit 192 discretizes the input spike time, the membrane potential calculation unit 193 calculates the membrane potential, and the firing time calculation unit 194 calculates the firing time) can be relatively shortened.

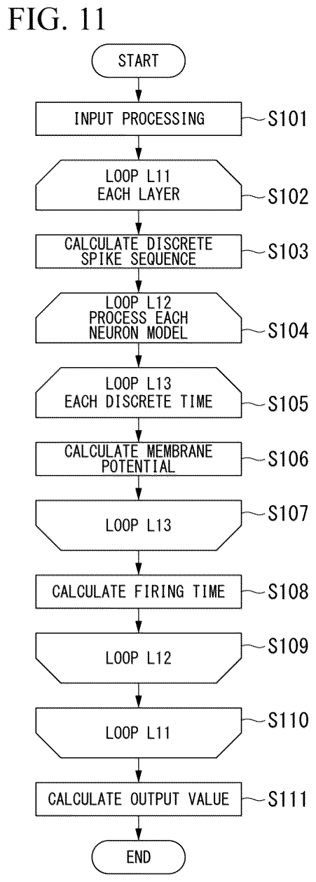

FIG. 11 is a diagram showing an example of the processing procedure by which the learning device 100 calculates the output value of the spiking neural network 200.

In the processing of FIG. 11, the mathematical model calculation unit 191 acquires the input spike time t⁽⁰⁾ᵢ to the first layer, from the input data to the spiking neural network 200 (step S101).

Next, the control unit 190 starts loop L11 in which processing is performed on each of the first layer to the Lth layer (final layer) of the spiking neural network 200 (step S102). Here, the layer being processed in loop L11 is referred to as the l-th layer.

In the processing of loop L11, the discretization unit 192 discretizes the input spike time based on expression (2l) and calculates a discrete spike sequence (step S103).

Next, the control unit 190 starts loop L12 that processes each neuron model 300 from the 1st to the N^{(l)}ₜₕ in the l-th layer (all neuron models 300 in the l-th layer) (step S104). Here, the neuron model 300 that is the target of processing in loop L12 is referred to as the i-th neuron model 300. Moreover, the neuron model 300 that is the target of processing in loop L12 is also referred to as the target neuron model. The control unit 190 may execute the processing of loop L12 in parallel.

In the processing of loop L12, the control unit 190 starts loop L13 in which processing is performed for each discrete time that has been set (step S105). Here, the discrete time that is being processed in loop L13 is denoted as discrete time T^{(l,m)}.

In the processing of loop L13, the membrane potential calculation unit 193 calculates the membrane potential v^{(l,m)}; of the target neuron model at the discrete time T^{(l,m)}, based on expression (17) (step S106).

Next, the control unit 190 performs termination processing of loop L13 (step S107). Specifically, the control unit 190 determines whether or not the processing of loop L13 has been performed for all discrete times from T^{(l,1)} to T^{(l,M)}. If it is determined that there is a discrete time for which the processing of loop L13 has not yet been performed, the control unit 190 continues the processing of loop L13 for the unprocessed discrete time.

On the other hand, if it is determined that the processing of loop L13 has been performed for all discrete times, the control unit 190 terminates loop L13.

In a case where the control unit 190 has finished the processing of loop L13, the firing time calculation unit 194 calculates the firing time t^{(l)}; of the target neuron model, based on the membrane potential v^{(l,M)}ᵢ at the end of the charging phase (step S108).

Next, the control unit 190 performs the termination process of loop L12 (step S109). Specifically, the control unit 190 determines whether or not the processing of loop L12 has been performed for all neuron models 300 included in the l-th layer. If it is determined that there is a neuron model 300 for which the processing of loop L12 has not yet been performed, the control unit 190 continues the processing of loop L12 for the unprocessed neuron model 300.

On the other hand, if it is determined that the processing of loop L12 has been performed for all neuron models 300, the control unit 190 terminates loop L12.

In a case where loop L12 has been completed, the control unit 190 performs the termination process of loop L11 (step S110). Specifically, the control unit 190 determines whether or not the processing of loop L11 has been performed for all layers from the layer 1 to layer L. If it is determined that there is a layer for which the processing of loop L11 has not yet been performed, the control unit 190 continues the processing of loop L11 for the unprocessed layer.

On the other hand, if it is determined that the processing of loop L11 has been performed for all layers, the control unit 190 terminates loop L11.

In a case where the control unit 190 ends loop L11, the mathematical model calculation unit 191 calculates the output value of the spiking neural network 200 (step S111). For example, in a case where the spiking neural network 200 performs class classification, each of the neuron models 300 in the output layer (L-th layer) of the spiking neural network 200 may be linked to a class. Then, the mathematical model calculation unit 191 may select, as the output of the spiking neural network 200, the class linked to the neuron model 300 with the earliest firing time among the neuron models 300 in the output layer.

After step S111, the learning device 100 terminates the process of FIG. 11.

Note that the application scene of the process in which the learning device 100 executes the calculation by the spiking neural network 200 is not limited to the learning scene of the spiking neural network 200. For example, in a case where performing verification for practical use of the spiking neural network 200, the learning device 100 may execute the calculation by the spiking neural network 200 by discretizing the input spike time using a mathematical model of the trained spiking neural network 200.

In this case, the learning device 100 may be configured as a calculation device that does not include the learning unit 195.

As described above, the discretization unit 192 converts the input spike time for each input spike to the neuron model 300, into a discrete-time input value, which is a value at a discrete time (discretized time). The input spike to the neuron model 300 corresponds to an example of an input signal to the neuron model 300. The input spike time corresponds to an example of the input time of the input signal.

The membrane potential calculation unit 193 calculates the membrane potential of the neuron model 300 at the discrete time, based on the discrete-time input value calculated by the discretization unit 192.

The firing time calculation unit 194 calculates the firing time of the neuron model 300, based on the membrane potential calculated by the membrane potential calculation unit 193.

According to the learning device 100, by discretizing the input spike time, it is possible to relatively shorten the time required for calculation in a case where performing calculations using the spiking neural network 200 composed of a mathematical model. In particular, according to the learning device 100, even if there are a large number of neuron models 300 that are the source of spike output, it is possible to calculate the firing time of each neuron model 300 by repeating the calculation of the membrane potential for the number of discrete times.

Furthermore, the discretization unit 192 calculates the discrete-time input value, based on the length of time between the input spike time and the discrete time.

According to the learning device 100, it is possible to assign the input spike time to a discrete time according to the length of time between the input spike time and the discrete time (i.e. the distance between the input spike time and the discrete time). According to the learning device 100, in this respect, it is expected that the firing time of the neuron model 300 can be calculated with high accuracy.

Furthermore, the discretization unit 192 calculates the discrete-time input value at the first time which is the time immediately before the input spike time, and the discrete-time input value at the second time which is the time immediately after the input spike time, in accordance with the proportion of the inverse ratio of the first time length, which is the length of time from the first time to the input spike time, and the second time length, which is the length of time from the input spike time to the second time.

According to the learning device 100, the input spike time can be assigned to a discrete time, according to the length of time between the input spike time and the discrete time (i.e. the distance between the input spike time and the discrete time). According to the learning device 100, in this respect, it is expected that the firing time of the neuron model 300 can be calculated with high accuracy.

Furthermore, according to the learning device 100 it is possible to partially differentiate the discrete-time input value with respect to the input spike time. As a result, the learning device 100 can perform learning of the spiking neural network 200 using a learning algorithm that uses differentiation, such as the backpropagation method.

Furthermore, the membrane potential calculation unit 193 calculates the membrane potential at the next discrete time, by substituting the membrane potential at the discrete time into an equation corresponding to the discrete-time input value.

According to the learning device 100, it is only necessary to calculate the membrane potential for each discrete time, and in this respect, it is possible to relatively shorten the time required for calculation in a case where performing calculations using the spiking neural network 200 composed of a mathematical model. In particular, according to the learning device 100, even if there are a large number of neuron models 300 that are the source of spike output, it is possible to calculate the firing time of each neuron model 300 by repeating the calculation of the membrane potential for the number of discrete times.

In addition, a random offset is added to the discrete time.

According to the learning device 100, it is possible to prevent a decrease in learning accuracy due to repeated learning using a specific discrete time sequence.

### Second Example Embodiment

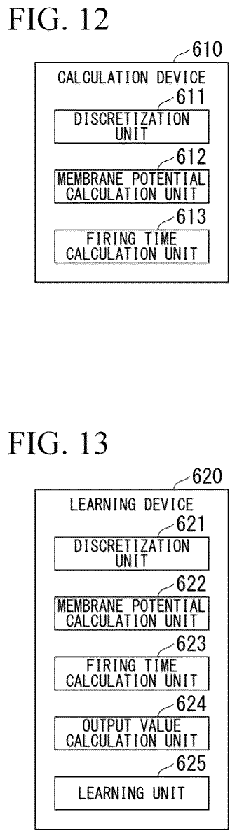

FIG. 12 is a diagram showing an example of the configuration of a calculation device according to at least one example embodiment. In the configuration shown in FIG. 12, the calculation device 610 includes a discretization unit 611, a membrane potential calculation unit 612, and a firing time calculation unit 613.

In this configuration, for each input signal to the spiking neuron model, the discretization unit 611 converts the input time of that input signal, into a discrete-time input value, which is the value at the discretized time. The membrane potential calculation unit 612 calculates the membrane potential of the spiking neuron model at the discretized time, based on the discrete-time input value. The firing time calculation unit 613 calculates the firing time of the spiking neuron model, based on the calculated membrane potential.

The discretization unit 611 corresponds to an example of a discretization means. The membrane potential calculation unit 612 corresponds to an example of a membrane potential calculation means. The firing time calculation unit 613 corresponds to an example of a firing time calculation means.

According to the calculation device 610, by discretizing the input time of the input signal, it is possible to relatively shorten the time required for calculation in a case where performing calculations using a spiking neural network composed of a mathematical model. In particular, according to the calculation device 610, even if there are a large number of neuron models that are the output sources of the input signal, it is possible to calculate the firing time of each neuron model by repeating the calculation of the membrane potential for the number of discrete times.

### Third Example Embodiment

FIG. 13 is a diagram showing an example of the configuration of a learning device according to at least one example embodiment. In the configuration shown in FIG. 13, the learning device 620 includes a discretization unit 621, a membrane potential calculation unit 622, a firing time calculation unit 623, an output value calculation unit 624, and a learning unit 625.

In this configuration, the discretization unit 621 converts the input time of each input signal to the spiking neuron model, into a discrete-time input value, which is a value at the discretized time. The membrane potential calculation unit 622 calculates the membrane potential of the spiking neuron model at the discretized time, based on the discretized time input value. The firing time calculation unit 623 calculates the firing time of the spiking neuron model, based on the calculated membrane potential. The output value calculation unit 624 calculates the output value of the spiking neural network using the spiking neuron model, based on the firing time of the spiking neuron model. The learning unit 625 updates the value of the learning parameter of the spiking neural network, based on the output value of the spiking neural network.

The discretization unit 621 corresponds to an example of a discretization means. The membrane potential calculation unit 622 corresponds to an example of a membrane potential calculation means. The firing time calculation unit 623 corresponds to an example of a firing time calculation means. The output value calculation unit 624 corresponds to an example of an output value calculation means. The learning unit 625 corresponds to an example of a learning means.

According to the learning device 620, the input time of the input signal to the neuron model is discretized, and therefore, in a case where performing calculations using a spiking neural network composed of a mathematical model, the time required for calculation can be relatively short. In particular, according to the learning device 620, even if there are a large number of neuron models that are the output sources of the input signal, it is possible to calculate the firing time of each neuron model by repeating the calculation of the membrane potential for the number of discrete times. As a result, it is expected that the learning device 620 can relatively shorten the learning time of the spiking neural network.

### Fourth Example Embodiment

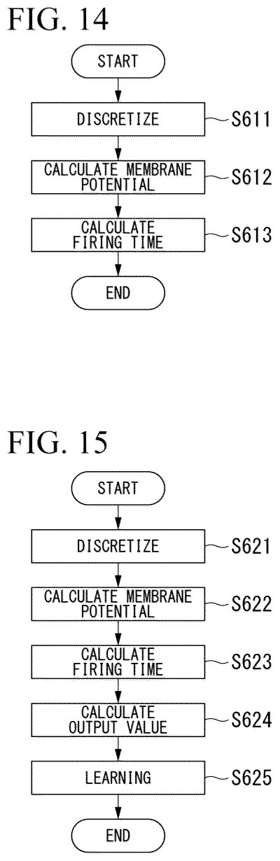

FIG. 14 is a diagram showing an example of the processing procedure in a calculation method according to at least one example embodiment. The calculation method shown in FIG. 14 includes discretizing (step S611), calculating the membrane potential (step S612), and calculating the firing time (step S613).

In discretization (step S611), the computer converts the input time of each input signal to the spiking neuron model, into a discrete-time input value, which is a value at the discretized time.

In calculating the membrane potential (step S612), the computer calculates the membrane potential of the spiking neuron model at the discretized time, based on the discrete-time input value.

In calculating the firing time (step S613), the computer calculates the firing time of the spiking neuron model, based on the calculated membrane potential.

According to the calculation method shown in FIG. 14, by discretizing the input time of the input signal, it is possible to relatively shorten the time required for calculation in a case where performing calculations using a spiking neural network composed of a mathematical model. In particular, according to the calculation method shown in FIG. 14, even if there are a large number of neuron models that are the output sources of the input signals, it is possible to calculate the firing time of each neuron model by repeating the calculation of the membrane potential for the number of discrete times.

### Fifth Example Embodiment

FIG. 15 is a diagram showing an example of a processing procedure in a learning method according to at least one example embodiment. The learning method shown in FIG. 15 includes discretizing (step S621), calculating the membrane potential (step S622), calculating the firing time (step S623), calculating the output value (step S624), and learning (step S625).

In discretizing (step S621), the computer converts the input time of each input signal to the spiking neuron model, into a discrete-time input value, which is a value at the discretized time.

In calculating the membrane potential (step S622), the computer calculates the membrane potential of the spiking neuron model at the discretized time, based on the discrete-time input value.

In calculating the firing time (step S623), the computer calculates the firing time of the spiking neuron model, based on the calculated membrane potential.

In calculating the output value (step S624), the computer calculates the output value of the spiking neural network using the spiking neuron model, based on the firing time of the spiking neuron model.

In learning (step S625), the computer updates the values of the learning parameters of the spiking neural network, based on the output value of the spiking neural network.

According to the learning method shown in FIG. 15, by discretizing the input time of the input signal to the neuron model, it is possible to relatively shorten the time required for calculation in a case where performing calculations using a spiking neural network composed of a mathematical model. In particular, according to the learning method shown in FIG. 15, even if there are a large number of neuron models that are the output sources of the input signals, it is possible to calculate the firing time of each neuron model by repeating the calculation of the membrane potential for the number of discrete times. As a result, it is expected that the learning method shown in FIG. 15 can relatively shorten the learning time of the spiking neural network.

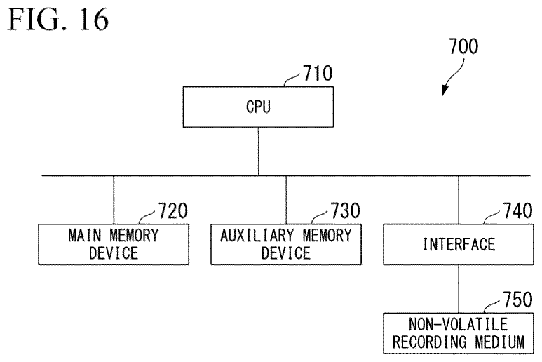

FIG. 16 is a diagram showing an example of a computer configuration according to at least one example embodiment. In the configuration shown in FIG. 16, the computer 700 includes a CPU 710, a main memory device 720, an auxiliary memory device 730, an interface 740, and a non-volatile recording medium 750.

Any one or more of the learning device 100, the calculation device 610, and the learning device 620, or a part thereof, may be implemented in the computer 700. In this case, the operation of each of the above-mentioned processing units is stored in the auxiliary memory device 730 in the form of a program. The CPU 710 reads the program from the auxiliary memory device 730, expands it in the main memory device 720, and executes the above-mentioned processing according to the program. The CPU 710 also secures a storage area in the main memory device 720 corresponding to each of the above-mentioned storage units according to the program. Communication between each device and other devices is executed by the interface 740 having a communication function and communicating according to the control of the CPU 710. The interface 740 also has a port for the non-volatile recording medium 750, and reads information from the non-volatile recording medium 750, and writes information to the non-volatile recording medium 750.

In a case where the learning device 100 is implemented in the computer 700, the operation of the control unit 190 and each of its units is stored in the auxiliary storage device 730 in the form of a program. The CPU 710 reads the program from the auxiliary storage device 730, expands it in the main storage device 720, and executes the above-mentioned processing according to the program.

Furthermore, the CPU 710 secures a storage area for the storage unit 180 in the main storage device 720 according to the program. Communication with other devices by the communication unit 110 is executed by the interface 740 having a communication function and operating according to the control of the CPU 710. Display of images by the display unit 120 is executed by the interface 740 having a display device and displaying various images according to the control of the CPU 710. Reception of user operations by the operation input unit 130 is executed by the interface 740 having an input device and receiving user operations according to the control of the CPU 710.

In a case where the calculation device 610 is implemented in the computer 700, the operations of the discretization unit 611, the membrane potential calculation unit 612, and the firing time calculation unit 613 are stored in the auxiliary storage device 730 in the form of a program. The CPU 710 reads the program from the auxiliary storage device 730, expands it in the main storage device 720, and executes the above-mentioned processing according to the program.

Furthermore, the CPU 710 secures a storage area in the main storage device 720 for the calculation device 610 to perform processing, according to the program. Communication between the calculation device 610 and other devices is executed by the interface 740 having a communication function and operating according to the control of the CPU 710. Interaction between the calculation device 610 and a user is executed by the interface 740 having an input device and an output device, presenting information to the user via the output device according to the control of the CPU 710, and receiving user operations via the input device.

In a case where the learning device 620 is implemented in the computer 700, the operations of the discretization unit 621, the membrane potential calculation unit 622, the firing time calculation unit 623, the output value calculation unit 624, and the learning unit 625 are stored in the auxiliary storage device 730 in the form of a program. The CPU 710 reads the program from the auxiliary storage device 730, expands it in the main storage device 720, and executes the above-mentioned processing according to the program.

Furthermore, the CPU 710 secures a storage area in the main storage device 720 for the learning device 620 to perform processing, according to the program. Communication between the learning device 620 and other devices is executed by the interface 740 having a communication function and operating according to the control of the CPU 710. Interaction between the learning device 620 and a user is executed by the interface 740 having an input device and an output device, presenting information to the user on the output device according to the control of the CPU 710, and receiving user operations on the input device.

Any one or more of the above-mentioned programs may be recorded on the non-volatile recording medium 750. In this case, the interface 740 may read the program from the non-volatile recording medium 750. The CPU 710 may then directly execute the program read by the interface 740, or may temporarily store the program in the main memory device 720 or the auxiliary memory device 730 and execute it.

In addition, a program for executing all or part of the processing performed by the learning device 100, the calculation device 610, and the learning device 620 may be recorded on a computer-readable recording medium, and the program recorded on the recording medium may be read into a computer system and executed to perform processing of each part. Note that the term “computer system” here includes hardware such as an OS (Operating System) and peripheral devices.

In addition, the term “computer-readable recording medium” refers to portable media such as flexible disks, optical magnetic disks, ROMs (Read Only Memory), and CD-ROMs (Compact Disc Read Only Memory), and storage devices such as hard disks built into a computer system. The above program may be for realizing part of the above-mentioned functions, or may be capable of realizing the above-mentioned functions in combination with a program already recorded in the computer system.

The above describes the example embodiments of the present disclosure in detail with reference to the drawings, but the specific configuration is not limited to these example embodiments, and also includes designs that do not deviate from the gist of the present disclosure.

According to the present disclosure, in a case where performing a calculation using a spiking neural network composed of a mathematical model, the time required for the calculation can be relatively short.

While preferred example embodiments of the disclosure have been described and illustrated above, it should be understood that these are example embodiments of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

A part or all of the above example embodiments may be described as, but are not limited to, the following supplementary notes.

### Supplementary Note 1

A calculation device comprising:
a discretization means that converts, for each input signal to a spiking neuron model, an input time of the input signal, into a discrete-time input value, which is a value at a discretized time;
a membrane potential calculation means that calculates a membrane potential of the spiking neuron model at the discretized time, based on the discrete-time input value; and
a firing time calculation means that calculates a firing time of the spiking neuron model, based on the calculated membrane potential.

### Supplementary Note 2

The calculation device according to supplementary note 1, wherein the discretization means calculates the discrete-time input value based on a length of time between the input time of the input signal and the discretized time.

### Supplementary Note 3

The calculation device according to supplementary note 2, wherein among the discretized times, the discretization means calculates a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

### Supplementary Note 4

The calculation device according to any one of supplementary notes 1 to 3, wherein the membrane potential calculation means calculates a membrane potential at a next time among the discretized times by substituting the membrane potential at the discretized time into an equation corresponding to the discrete-time input value.

### Supplementary Note 5

The calculation device according to any one of supplementary notes 1 to 4, wherein a random offset is added to the discretized time.

### Supplementary Note 6

A learning device comprising:
a discretization means that converts, for each input signal to a spiking neuron model, an input time of the input signal, into a discrete-time input value, which is a value at a discretized time;
a membrane potential calculation means that calculates a membrane potential of the spiking neuron model at the discretized time, based on the discrete-time input value;
a firing time calculation means that calculates a firing time of the spiking neuron model, based on the calculated membrane potential;
an output value calculation means that calculates an output value of a spiking neural network using the spiking neuron model, based on the firing time; and
a learning means that updates values of learning parameters of the spiking neural network, based on the output value.

### Supplementary note 7

The learning device according to supplementary note 6, wherein the discretization means calculates the discrete-time input value, based on the length of time between the input time of the input signal and the discretized time.

### Supplementary Note 8

The learning device according to supplementary note 7, wherein among the discretized times, the discretization means calculates a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

### Supplementary Note 9

The learning device according to any one of supplementary notes 6 to 8, wherein the membrane potential calculation means calculates the membrane potential at a next time among the discretized times by substituting the membrane potential at the discretized time into an equation corresponding to the discrete-time input value.

### Supplementary Note 10

The learning device according to any one of supplementary notes 6 to 9, wherein a random offset is added to the discretized time.

### Supplementary Note 11

A calculation method comprising computer implemented steps of:
converting, for each input signal to a spiking neuron model, an input time of the input signal, into a discrete-time input value, which is a value at a discretized time;
calculating a membrane potential of the spiking neuron model at the discretized time, based on the discrete-time input value; and
calculating a firing time of the spiking neuron model, based on the calculated membrane potential.

### Supplementary Note 12

The calculation method according to supplementary note 11, wherein the conversion involves calculating the discrete-time input value, based on the length of time between the input time of the input signal and the discretized time.

### Supplementary Note 13

The calculation method according to supplementary note 12, wherein the conversion involves calculating a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

### Supplementary Note 14

The calculation method according to any one of supplementary notes 11 to 13, wherein calculating the membrane potential at a next time among the discretized times involves substituting the membrane potential at the discretized time into an equation corresponding to the discrete-time input value.

### Supplementary Note 15

The calculation method according to any one of supplementary notes 11 to 14, wherein a random offset is added to the discretized time.

### Supplementary Note 16

A learning method comprising computer implemented steps of:
converting, for each input signal to a spiking neuron model, an input time of the input signal, into a discrete-time input value, which is a value at a discretized time;
calculating a membrane potential of the spiking neuron model at the discretized time, based on the discrete-time input value;
calculating a firing time of the spiking neuron model, based on the calculated membrane potential;
calculating an output value of a spiking neural network using the spiking neuron model, based on the firing time; and
updating a value of a learning parameter of the spiking neural network, based on the output value.

### Supplementary Note 17

The learning method according to supplementary note 16, wherein the conversion involves calculating the discrete-time input value, based on the length of time between the input time of the input signal and the discretized time.

### Supplementary Note 18

The learning method according to supplementary note 17, wherein the conversion involves calculating a discrete-time input value at a first time which is the time immediately before the input time, and a discrete-time input value at a second time which is the time immediately after the input time, in accordance with the proportion of an inverse ratio of a first time length, which is the length of time from the first time to the input time, and a second time length, which is the length of time from the input time to the second time.

### Supplementary Note 19

The learning method described in any one of supplementary notes 16 to 18, wherein calculating the membrane potential at a next time among the discretized times involves substituting the membrane potential at the discretized time into an equation corresponding to the discretized time input value.

### Supplementary Note 20

The learning method according to any one of supplementary notes 16 to 19, wherein a random offset is added to the discretized time.

### Supplementary Note 21

A program stored in a non-transitory storage medium that causes a computer to execute steps of:
converting, for each input signal to a spiking neuron model, an input time of the input signal, into a discrete-time input value, which is a value at a discretized time;
calculating a membrane potential of the spiking neuron model at the discretized time, based on the discrete-time input value; and
calculating a firing time of the spiking neuron model, based on the calculated membrane potential.

### Supplementary Note 22

The program according to supplementary note 21 wherein the conversion involves causing the computer to execute a step of calculating the discrete-time input value, based on the length of time between the input time of the input signal and the discretized time.

### Supplementary Note 23

The program according to supplementary note 22, wherein the conversion involves causing the computer to execute steps of;
calculating among the discretized times, a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

### Supplementary Note 24

The program according to any one of supplementary notes 21 to 23, wherein calculating the membrane potential involves causing the computer to execute the step of;
substituting the membrane potential at the discretized time into an equation corresponding to the discrete-time input value, to calculate the membrane potential at a next time among the discretized times.

### Supplementary Note 25

The program according to any one of supplementary notes 21 to 24, wherein a random offset is added to the discretized time.

### Supplementary Note 26

A program stored in a non-transitory storage medium that causes a computer to execute steps of:
converting, for each input signal to a spiking neuron model, an input time of the input signal, into a discrete-time input value, which is a value at the discretized time;
calculating a membrane potential of the spiking neuron model at the discretized time, based on the discrete-time input value;
calculating a firing time of the spiking neuron model, based on the calculated membrane potential;
calculating an output value of a spiking neural network using the spiking neuron model, based on the firing time; and
updating a value of a learning parameter of the spiking neural network, based on the output value.

### Supplementary Note 27

The program according to supplementary note 26, wherein the conversion involves causing the computer to execute a step of calculating the discrete-time input value, based on a length of time between an input time of the input signal and the discretized time.

### Supplementary Note 28

The program according to supplementary note 27, wherein the conversion involves causing the computer to execute a step of:
calculating among the discretized times, a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

### Supplementary Note 29

The program according to any one of supplementary notes 26 to 28, wherein calculating the membrane potential involves causing the computer to execute a step of;
substituting the membrane potential at the discretized time into an equation corresponding to the discrete-time input value, to calculate the membrane potential at a next time among the discretized times.

### Supplementary Note 30

The program according to any one of supplementary note 26 to 29, wherein a random offset is added to the discretized time.

What is claimed is:

1. A calculation device comprising:
at least one memory configured to store instructions; and
at least one processor configured to execute the instructions to:
convert, for each input signal to a spiking neuron model, an input time of the input signal, into a discrete-time input value, which is a value at a discretized time;
calculate a membrane potential of the spiking neuron model at the discretized time, based on the discrete-time input value; and
calculate a firing time of the spiking neuron model, based on the calculated membrane potential.

2. The calculation device according to claim 1, wherein the at least one processor is configured to execute the instructions to calculate the discrete-time input value based on a length of time between the input time of the input signal and the discretized time.

3. The calculation device according to claim 2, wherein the at least one processor is configured to execute the instructions to calculate, among the discretized times, a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

4. The calculation device according to claim 1, wherein the at least one processor is configured to execute the instructions to calculate a membrane potential at a next time among the discretized times by substituting the membrane potential at the discretized time into an equation corresponding to the discrete-time input value.

5. The calculation device according to claim 1, wherein a random offset is added to the discretized time.

6. A learning device comprising:
at least one memory configured to store instructions; and
at least one processor configured to execute the instructions to:
convert, for each input signal to a spiking neuron model, an input time of the input signal, into a discrete-time input value, which is a value at a discretized time;
calculate a membrane potential of the spiking neuron model at the discretized time, based on the discrete-time input value;
calculate a firing time of the spiking neuron model, based on the calculated membrane potential;
calculate an output value of a spiking neural network using the spiking neuron model, based on the firing time; and
update values of learning parameters of the spiking neural network, based on the output value.

7. The learning device according to claim 6, wherein the at least one processor is configured to execute the instructions to calculate the discrete-time input value, based on the length of time between the input time of the input signal and the discretized time.

8. The learning device according to claim 7, wherein the at least one processor is configured to execute the instructions to calculate, among the discretized times, a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

9. The learning device according to claim 6, wherein the at least one processor is configured to execute the instructions to calculate the membrane potential at a next time among the discretized times by substituting the membrane potential at the discretized time into an equation corresponding to the discrete-time input value.

10. The learning device according to claim 6, wherein a random offset is added to the discretized time.

11. A calculation method executed by a computer, the method comprising:
converting, for each input signal to a spiking neuron model, an input time of the input signal, into a discrete-time input value, which is a value at a discretized time;
calculating a membrane potential of the spiking neuron model at the discretized time, based on the discrete-time input value; and
calculating a firing time of the spiking neuron model, based on the calculated membrane potential.

12. The calculation method according to claim 11, wherein the converting includes calculating the discrete-time input value, based on the length of time between the input time of the input signal and the discretized time.

13. The calculation method according to claim 12, wherein the converting includes calculating a discrete-time input value at a first time which is the time immediately before the input time, and a discrete-time input value at a second time which is the time immediately after the input time, in accordance with the proportion of the inverse ratio of a first time length, which is the length of time from the first time to the input time, and a second time length, which is the length of time from the input time to the second time.

14. The calculation method according to claim 11, wherein calculating the membrane potential at a next time among the discretized times includes substituting the membrane potential at the discretized time into an equation corresponding to the discrete-time input value.

15. The calculation method according to claim 11, wherein a random offset is added to the discretized time.
